(19) United States
(12) Patent Application Publication
(10) Pub. No.: US 2026/0333452 A1
(43) Pub. Date: Oct. 22, 2026

(54) PREAMBLE STRUCTURE FOR RANDOM ACCESS

(71) Applicant: Lenovo (United States) Inc., Morrisville, NC (US)

(72) Inventors: Sher Ali Cheema, Ilmenau (DE); Ali Ramadan Ali, Kraiburg (DE); Karthikeyan Ganesan, Nauheim (DE)

(73) Assignee: Lenovo (United States) Inc., Morrisville, NC (US)

(21) Appl. No.: 19/295,346

(22) Filed: Aug. 8, 2025

(51) Int. Cl. H04W 74/0833; G01S 19/39; H04L 27/26

(52) U.S. Cl. CPC H04W 74/0833; G01S 19/396; H04L 27/2607

(57) ABSTRACT

Various aspects of the present disclosure relate to assistance information for time and frequency synchronization. An apparatus, such as a user equipment (UE), receives assistance information for synchronization in a non-terrestrial network (NTN), the assistance information applicable to a coverage area and including a set of baseline synchronization correction parameters. The UE selects a baseline synchronization correction parameter based on a Global Navigation Satellite System (GNSS) location being unavailable for the UE. The UE applies the selected baseline synchronization correction parameter to a baseline time and frequency synchronization parameter to calculate an initial uplink pre-compensation value, and transmits an uplink signal for initial access using the initial uplink pre-compensation value. Additionally, or alternatively, the UE calculates the initial uplink pre-compensation value based on second assistance information specific to a zone of the coverage area.

### TECHNICAL FIELD

The present disclosure relates to wireless communications, and more specifically to assistance information for time and frequency synchronization.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive assistance information for synchronization in a non-terrestrial network (NTN), where the assistance information is applicable to a coverage area and includes a set of baseline synchronization correction parameters; select, based on a Global Navigation Satellite System (GNSS) location being unavailable for the UE, a baseline synchronization correction parameter from the set of baseline synchronization correction parameters; calculate an initial uplink pre-compensation value by applying the selected baseline synchronization correction parameter to a baseline time and frequency synchronization parameter; and transmit an uplink signal for initial access using the initial uplink pre-compensation value.

A processor (e.g., a standalone processor chipset, or a component of a UE) for wireless communication is described. The processor may be configured to, capable of, or operable to perform one or more operations as described herein. For example, the processor may be configured to, capable of, or operable to receive assistance information for synchronization in an NTN, where the assistance information is applicable to a coverage area and includes a set of baseline synchronization correction parameters; select, based on a GNSS location being unavailable for the UE, a baseline synchronization correction parameter from the set of baseline synchronization correction parameters; calculate an initial uplink pre-compensation value by applying the selected baseline synchronization correction parameter to a baseline time and frequency synchronization parameter; and transmit an uplink signal for initial access using the initial uplink pre-compensation value.

A method performed or performable by a UE for wireless communication is described. The method may include receiving assistance information for synchronization in an NTN, where the assistance information is applicable to a coverage area and includes a set of baseline synchronization correction parameters; selecting, based on a GNSS location being unavailable for the UE, a baseline synchronization correction parameter from the set of baseline synchronization correction parameters; calculating an initial uplink pre-compensation value by applying the selected baseline synchronization correction parameter to a baseline time and frequency synchronization parameter; and transmitting an uplink signal for initial access using the initial uplink pre-compensation value.

In some implementations of the UE, the processor, and the method described herein, the UE, the processor, and the method may further be configured to, capable of, operable to, performed to, or performable to receive second assistance information for the synchronization, where the second assistance information includes a set of zone identifiers, and where each zone identifier of the set of zone identifiers is associated with a zone and at least one zone-specific synchronization correction parameter; and select a zone identifier from the set of zone identifiers based on a coarse location of the UE, where the baseline synchronization correction parameter is selected based on the selected zone identifier, and where the baseline synchronization correction parameter corresponds to a respective zone-specific synchronization parameter associated with the selected zone identifier.

In some implementations of the UE, the processor, and the method described herein, the zone is associated with a synchronization signal block (SSB) beam. In some implementations of the UE, the processor, and the method described herein, the assistance information further includes satellite ephemeris data, and where the respective zone-specific synchronization correction parameter is selected based on the satellite ephemeris data. In some implementations of the UE, the processor, and the method described herein, in response to the set of zone identifiers excluding the coarse location of the UE, the initial uplink pre-compensation value is calculated based on the assistance information.

In some implementations of the UE, the processor, and the method described herein, the UE, the processor, and the method may further be configured to, capable of, operable to, performed to, or performable to initiate a validity timer associated with the assistance information or the second assistance information; and refrain from using the assistance information or the second assistance information if an age of the assistance information exceeds a duration of the validity timer.

In some implementations of the UE, the processor, and the method described herein, the UE, the processor, and the method may further be configured to, capable of, operable to, performed to, or performable to transmit capability information that indicates support for synchronization in the NTN, where one or more of the assistance information or the second assistance information is received based on the transmitted capability information.

In some implementations of the UE, the processor, and the method described herein, the baseline time and frequency synchronization parameter is a baseline timing advance (TA) value applicable to a reference point of the coverage area and the zone-specific synchronization correction parameter is a differential TA value, and where, to calculate the initial uplink pre-compensation value, the at least one processor is further configured to cause the UE to add the differential TA value to the baseline TA value.

In some implementations of the UE, the processor, and the method described herein, the baseline time and frequency synchronization parameter is a common Doppler pre-compensation value applicable to a reference point of the coverage area and the zone-specific synchronization correction parameter is a differential Doppler value, and where, to calculate the initial uplink pre-compensation value, the at least one processor is further configured to cause the UE to apply the differential Doppler value to the common Doppler pre-compensation value.

In some implementations of the UE, the processor, and the method described herein, to calculate the initial pre-compensation value, the UE, the processor, and the method may further be configured to, capable of, operable to, performed to, or performable to receive an indication of a network reference time (NRT), where the initial uplink pre-compensation value is calculated based on the NRT.

An NE (e.g., a base station, a gNB) for wireless communication is described. The NE may be configured to, capable of, or operable to perform one or more operations as described herein. For example, the NE may be configured to, capable of, or operable to transmit assistance information for synchronization in an NTN, where the assistance information is applicable to a coverage area and includes a set of baseline synchronization correction parameters; and receive an uplink signal for initial access indicating an initial uplink pre-compensation value, where the initial uplink pre-compensation value is based on a baseline synchronization correction parameter being applied to a baseline time and frequency synchronization parameter, and where the baseline synchronization correction parameter is based on a GNSS location being unavailable for a UE.

A processor (e.g., a standalone processor chipset, or a component of a NE) for wireless communication is described. The processor may be configured to, capable of, or operable to perform one or more operations as described herein. For example, the processor may be configured to, capable of, or operable to transmit assistance information for synchronization in an NTN, where the assistance information is applicable to a coverage area and includes a set of baseline synchronization correction parameters; and receive an uplink signal for initial access indicating an initial uplink pre-compensation value, where the initial uplink pre-compensation value is based on a baseline synchronization correction parameter being applied to a baseline time and frequency synchronization parameter, and where the baseline synchronization correction parameter is based on a GNSS location being unavailable for a UE.

A method performed or performable by an NE (e.g., a base station) for wireless communication is described. The method may include transmitting assistance information for synchronization in an NTN, where the assistance information is applicable to a coverage area and includes a set of baseline synchronization correction parameters; and receiving an uplink signal for initial access indicating an initial uplink pre-compensation value, where the initial uplink pre-compensation value is based on a baseline synchronization correction parameter being applied to a baseline time and frequency synchronization parameter, and where the baseline synchronization correction parameter is based on a GNSS location being unavailable for a UE.

In some implementations of the NE, the processor, and the method described herein, the NE, the processor, and the method may further be configured to, capable of, operable to, performed to, or performable to transmit second assistance information for the uplink synchronization, where the second assistance information includes a set of zone identifiers and each zone identifier of the set of zone identifiers is associated with a zone and at least one zone-specific synchronization correction parameter, and where the initial uplink pre-compensation value is based on a zone-specific synchronization correction parameter associated with the zone identifier being applied to the baseline time and frequency synchronization parameter, the zone identifier based on a coarse location of the UE.

In some implementations of the NE, the processor, and the method described herein, the zone is associated with an SSB beam. In some implementations of the NE, the processor, and the method described herein, the assistance information further includes satellite ephemeris data, and where the respective zone-specific synchronization correction parameter is selected based on the satellite ephemeris data.

In some implementations of the NE, the processor, and the method described herein, in response to the set of zone identifiers excluding the coarse location of the UE, the initial uplink pre-compensation value is calculated based on the assistance information. In some implementations of the NE, the processor, and the method described herein, the NE, the processor, and the method may further be configured to, capable of, operable to, performed to, or performable to receive capability information that indicates UE support for synchronization in the NTN, where one or more of the assistance information or the second assistance information is transmitted based on the received capability information.

In some implementations of the NE, the processor, and the method described herein, the baseline time and frequency synchronization parameter is a baseline TA value applicable to a reference point of the coverage area and the zone-specific synchronization correction parameter is a differential TA value, and where the initial uplink pre-compensation value is based on the differential TA value being added to the baseline TA value.

In some implementations of the NE, the processor, and the method described herein, the baseline time and frequency synchronization parameter is a common Doppler pre-compensation value applicable to a reference point of the coverage area and zone-specific synchronization correction parameter is a differential Doppler value, and where the initial uplink pre-compensation value is based on the differential Doppler value being applied to the common Doppler pre-compensation value.

In some implementations of the NE, the processor, and the method described herein, the NE, the processor, and the method may further be configured to, capable of, operable to, performed to, or performable to transmit an indication of an NRT, where the initial uplink pre-compensation value is based on the NRT.

### BRIEF DESCRIPTION OF THE DRAWINGS

FIG. 1 illustrates an example of a wireless communications system in accordance with aspects of the present disclosure.

FIG. 2 illustrates an example of an NTN in accordance with aspects of the present disclosure.

FIGS. 3A through 6 illustrate examples of information elements (IEs) in accordance with aspects of the present disclosure.

FIG. 7 illustrates an example of scenarios in accordance with aspects of the present disclosure.

FIG. 8 illustrates an example of a sub-block procedure in accordance with aspects of the present disclosure.

FIGS. 9 and 10 illustrate examples of scenarios in accordance with aspects of the present disclosure.

FIG. 11 illustrates an example of an IE in accordance with aspects of the present disclosure.

FIG. 12 illustrates an example of a UE in accordance with aspects of the present disclosure.

FIG. 13 illustrates an example of a processor in accordance with aspects of the present disclosure.

FIG. 14 illustrates an example of an NE in accordance with aspects of the present disclosure.

FIG. 15 illustrates a flowchart of a method performed by a UE in accordance with aspects of the present disclosure.

FIG. 16 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. In some cases, the wireless communications system may support an NTN, which may use components such as satellites, unmanned aerial vehicles (UAVs), or high-altitude platforms (HAPs) to provide wireless connectivity. NTNs may be integrated with UEs and NEs in the wireless communications system to extend coverage to remote, rural, or mobile environments where ground-based, terrestrial networks (TNs) may be limited or unavailable.

To access a New Radio (NR) NTN or an Internet-of-Things (IOT) NTN, a UE may require GNSS capabilities. GNSS coordinates enable a UE to know its position, which may be used to pre-compensate for a time and frequency shift due to the nature of the NTN. For example, an NR NTN may utilize an open loop timing adjustment procedure in a transparent payload NTN architecture, where a TA may be partitioned into a common TA (e.g., corresponding to a feeder link round-trip time (RTT)) and a user-specific TA (e.g., corresponding to a two-way transmission delay on a service link). To estimate the user-specific TA, the UE may need to know a position of a serving satellite, which an NE may indicate to the UE, and the UE's own location, which may be based on the GNSS. Additionally, as satellites (e.g., non-geostationary satellite orbit (NGSO)) satellites are constantly moving, the UE may continuously update TAs and frequency pre-compensation while in a connected mode to enable reliable communications. As such, to access an NTN, the UE may require a reliable GNSS connection over a time period of its entire connectivity.

Although GNSS provides a highly accurate position and time reference, some scenarios or occasions may occur in which GNSS signals may be unavailable for a period of time. For example, GNSS signals may experience outages or jams. Alternatively, GNSS signals may be falsified (i.e., spoofed), which may result in an inaccurate UE position, further resulting in denial of NTN connectivity in various scenarios as a user-specific TA resulting from an incorrect UE position may render subsequent uplink communication difficult. Such scenarios may also impact a group of UEs in a particular cell for a duration of time. Additionally, there may be scenarios in which a UE may experience a degradation in NTN service due to relatively reduced GNSS location estimates (e.g., accuracy may be reduced to 300 m) for various reasons (e.g., poor GNSS link budget, unavailability of a required number of satellites, a position of a device, for example in a pocket or bag, and so forth).

Moreover, some UEs in a cell may lack GNSS capability. Such UEs may be unable to connect to the NE because the UEs may perform inaccurate time and frequency synchronization procedures, which are based on first estimating a UE's own location using GNSS. For example, if such UEs perform a time and frequency synchronization without GNSS-based pre-compensation during initial access, a UE's first random access channel (RACH) preamble may arrive at the NE with potentially significant timing errors, due to an unknown RTT, and frequency errors, due to an unknown Doppler shift, thus increasing the rate of failure when accessing an NTN for numerous procedures.

The degradation, denial, or unavailability of NR NTN service, due to the temporary unavailability and/or inaccuracy of GNSS-based UE locations (e.g., because of spoofing or jamming), may lead to enhanced power consumption for UEs and overall system performance degradation. If the NE has knowledge of the temporary unavailability of GNSS signals in its coverage area, then the NE may devise a method to either prevent UEs from attempting to establish connections for a temporary period of time or provide the UE with alternative means for timing and frequency synchronization.

To reduce the rate of failure when accessing an NTN, the techniques described herein support alternative methods for time and frequency synchronization in NTN systems when a UE is unable to estimate its own location and perform an open loop TA procedure due to temporary unavailability and/or inaccuracy of its GNSS location or when the UE lacks GNSS capabilities. Specifically, the described techniques enable an NE to provide assistance information to the UE to provide at least a coarse time and frequency synchronization for uplink RACH transmissions when GNSS is unavailable. In some examples, the assistance information may include a set of parameters related to time and frequency pre-compensation, which may enable an initial coarse synchronization for a RACH transmission. Such coarse synchronization may increase the chances of RACH detection by the network. In some cases, the time and frequency parameters in the assistance information may also be associated with a cell, or the cell may be divided into zones, where finer sets of time and frequency parameters may be associated with respective zones. In such cases, the UE may use the parameters associated with the cell as baseline parameters that are common to all UEs in the cell, and the parameters associated with specific zones as zone-specific parameters with differential values for specific UEs in the respective zones. The UE may apply a combination of the baseline and zone-specific parameters to perform time and frequency synchronization.

In some implementations, the NE may broadcast the assistance information for each cell as part of a system information block (SIB) (e.g., SIB 19) for NTN. After the UE has detected SSBs and decoded a corresponding primary synchronization signal (PSS), secondary synchronization signal (PSS) or physical broadcast channel (PBCH) the UE may use the assistance information to perform coarse (or in some cases, a finer) uplink time and frequency synchronization for a RACH transmission. Specifically, the UE may receive assistance information from the NE for synchronization in an NTN. The assistance information may apply to a coverage area (e.g., of the NE) and include a set of baseline synchronization correction parameters. Based on a GNSS location (e.g., position fix) being unavailable for the UE (e.g., or if the GNSS is otherwise unavailable), the UE may select a baseline synchronization correction parameter from the set and apply the selected baseline synchronization correction parameter to a baseline time and frequency synchronization parameter. This may result in an initial uplink pre-compensation value. The UE may transmit an uplink signal for initial access (e.g., in a RACH procedure) using the initial uplink pre-compensation value.

Additionally, or alternatively, the NE may divide the coverage area of a cell into smaller zones and provide zone-specific assistance information. The zone-specific assistance information may include a set of coarse time and frequency parameters to compensate for a UE-specific propagation delay that the UE may be unable to calculate due to the unavailability of GNSS and the UE's own location estimates. Associating time and frequency parameters with zones or beams of a cell may be beneficial in reducing timing and frequency errors as NTN cells may be large and UEs at different locations within the cell may experience different timing variations based on UE locations and satellite movement. In such cases, the UE may receive the zone-specific assistance information (e.g., second assistance information), which may include a set of zone identifiers, each zone identifier associated with a zone of the cell and at least one zone-specific synchronization correction parameter. The UE may select a zone identifier from the set based on a coarse location of the UE, where the baseline synchronization correction parameter is selected based on the selected zone identifier, and the baseline synchronization correction parameter corresponds to a respective zone-specific synchronization correction parameter associated with the selected zone identifier.

Additionally, or alternatively, the NE may indicate an NRT to the UE to assist the UE synchronization its internal clock with the NE and to provide a coarse compensation of timing. This may provide a starting point to enable timing calculations for UEs without GNSS or UEs with less accurate GNSS location estimates. The NRT may be a timestamp indicating when a satellite transmitted a signal based on a synchronized clock at the NE. The NRT may assist UEs in the absence of GNSS to estimate propagation delays and synchronization transmissions, especially for UEs performing initial access. Performing the described techniques may improve power consumption for UEs and improve overall system performance prevent UEs from attempting to establish connections for a temporary period of time (e.g., when GNSS is unavailable or GNSS-based location estimates are inaccurate) or provide the UE with alternative means for timing and frequency synchronization.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

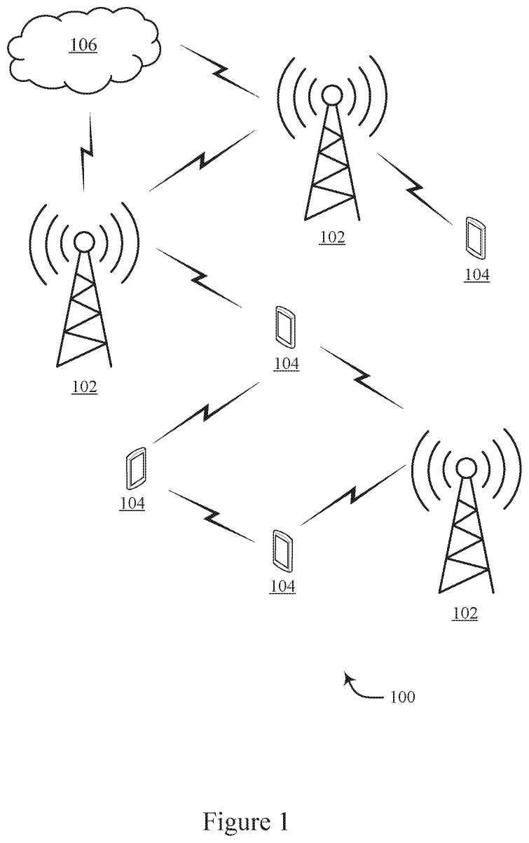

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an IoT device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) and a cyclic prefix. A first numerology (e.g., μ=0) may be associated with a first SCS (e.g., 15 kHz) and a normal cyclic prefix. In some implementations, the first numerology (e.g., μ=0) associated with the first SCS (e.g., 15 kHz) may utilize one slot per subframe. A second numerology (e.g., μ=1) may be associated with a second SCS (e.g., 30 kHz) and a normal cyclic prefix. A third numerology (e.g., μ=2) may be associated with a third SCS (e.g., 60 kHz) and a normal cyclic prefix or an extended cyclic prefix. A fourth numerology (e.g., μ=3) may be associated with a fourth SCS (e.g., 120 kHz) and a normal cyclic prefix. A fifth numerology (e.g., μ=4) may be associated with a fifth SCS (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective SCSs of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 kHz SCS.

According to implementations, one or more of the NEs 102 and the UEs 104 are operable to implement various aspects of the techniques described with reference to the present disclosure. For example, a UE 104 may receive assistance information from an NE 102 for synchronization in an NTN. The assistance information may apply to a coverage area (e.g., of the NE 102) and include a set of baseline synchronization correction parameters. Based on GNSS being unavailable for the UE 104 (e.g., such that a GNSS location is unavailable for the UE 104), the UE 104 may select a baseline synchronization correction parameter from the set and apply the selected baseline synchronization correction parameter to a baseline time and frequency synchronization parameter. This may result in an initial uplink pre-compensation value. The UE 104 may transmit an uplink signal for initial access (e.g., in a RACH procedure) using the initial uplink pre-compensation value. Additionally, or alternatively, the UE 104 may receive the zone-specific assistance information (e.g., second assistance information), which may include a set of zone identifiers, each zone identifier associated with a zone of the cell and at least one zone-specific synchronization correction parameter. The UE 104 may select a zone identifier from the set based on a coarse location of the UE 104 and calculate the initial uplink pre-compensation value by applying a zone-specific synchronization correction parameter associated with the selected zone identifier to the baseline time and frequency synchronization parameter.

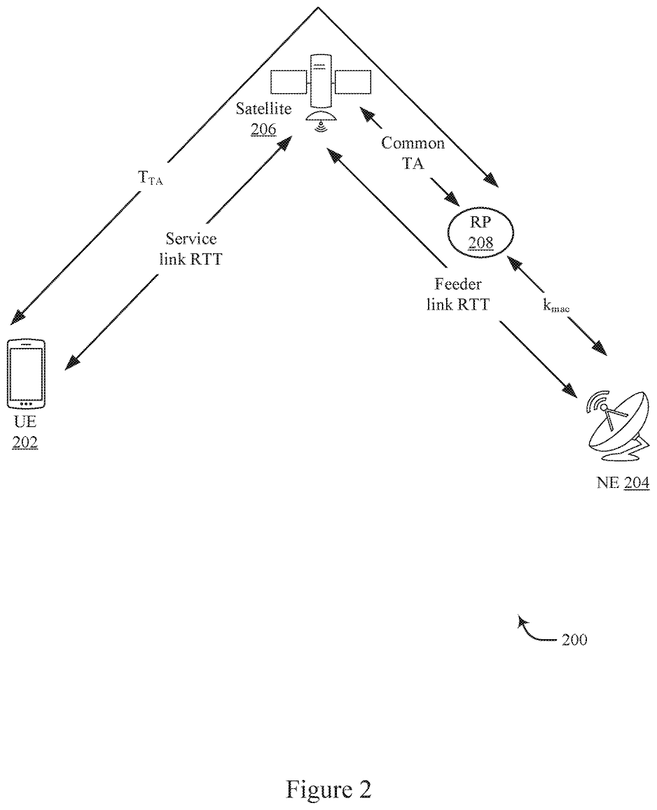

FIG. 2 illustrates an example of an NTN 200 in accordance with aspects of the present disclosure. The NTN 200 may support communications between a UE 202, an NE 204 (e.g., a gNB, a base station), and a satellite 206.

In the NTN 200, a downlink and an uplink may be frame aligned at an uplink time synchronization reference point (RP) 208, with an offset given by N_{TA,offset}. To accommodate a propagation delay in the NTN 200, several timing relationships may be enhanced by a common TA and two offsets, K_{offset} and k_{mac}. The common TA may represent a configured timing offset equal to the RTT between the RP 208 and the NTN payload. K_{offset} may represent a configured scheduling offset that has to be larger than or equal to the sum of the service link RTT and the common TA. K_{mac} may represent a configured offset that is approximately equal to the RTT between the RP 208 and the NE 204. In some cases, the scheduling offset K_{offset} may be used to allow the UE 202 sufficient processing time between a downlink reception and an uplink transmission. Additionally, or alternatively, the offset k_{mac} may be used to delay application of a downlink configured by a medium access control (MAC)-control element (MAC-CE) command on a physical downlink shared channel (PDSCH), and in estimation of a UE-NE RTT. The offset k_{mac} may be provided by the NE 204 when downlink and uplink frame timing are not aligned at the NE 204. In addition, the offset k_{mac} may be used in random access procedures to determine a start time of a random access response (RAR) window/MsgB window after a Msg1/MsgA transmission.

In some implementations, the NE 204 may configure a hybrid automatic repeat request (HARQ) operation for the NTN 200. For downlink, the NE 204 may enable or disable HARQ feedback per HARQ process. Disabling HARQ feedback may allow for scheduling a HARQ process before one HARQ RTT has elapsed since being last scheduled. For uplink, the NE 204 may configure a HARQ mode (i.e., HARQ mode A or HARQ mode B) per HARQ process. HARQ mode B may allow for scheduling a HARQ process before one HARQ RTT has elapsed since being last scheduled. For HARQ processes configured with HARQ feedback enabled or disabled, it may be up to network implementation to ensure a proper configuration of HARQ feedback (e.g., either all enabled or all disabled) for HARQ processed used for a semi-persistent scheduling (SPS) configuration. For HARQ processes configured with a HARQ mode, it may be up to network implementation to ensure a proper configuration of a HARQ mode (e.g., either all HARQ mode A or all HARQ mode B) for HARQ processes used by a configured grant (CG) configuration.

In some implementations, for a serving cell, the NE 204 may broadcast valid ephemeris information and common TA parameters. The UE 202 may have a valid GNSS position as well as ephemeris information and common TA parameters before connecting to an NTN cell (e.g., in the NTN 200). To achieve synchronization, before and after connection to an NTN cell, the UE 202 may compute an RTT between the UE 202 and the RP 208 based on the GNSS position of the UE 202, the ephemeris information, and the common TA parameters, and the UE 202 may autonomously pre-compensate the TTA for the RTT between the UE 202 and the RP 208. In some cases, the UE 202 may compute a frequency Doppler shift of the service link and autonomously pre-compensate for the frequency Doppler shift in subsequent uplink transmissions by considering the UE GNSS position and the ephemeris information. If the UE 202 lacks a valid GNSS position and/or valid ephemeris information and common TA parameters, the UE 202 may refrain from transmitting until the GNSS position, the ephemeris information, and the common TA parameters are regained.

In a connected mode (e.g., a radio resource control (RRC) connected mode), the UE 202 may be able to continuously update the common TA and frequency pre-compensation values. In some examples, the UE 202 may be configured to report a TA during a random access procedure or while in the connected mode. In the connected mode, the UE 202 may support event-triggered reporting of the TA. While the UE is to perform the pre-compensation of the instantaneous Doppler shift experienced on the service link, the management of the Doppler shift experienced over the feeder link and transponder frequency error may be left to network implementation.

In some examples, the NTN 200 may support a transmission timing adjustments procedure for TNs and NTNs. The UE 202 may be provided a value of NIA, offset, which may represent a TA offset for a serving cell, by n-TimingAdvanceOffset. If the UE 202 is not provided with n-TimingAdvanceOffset for a serving cell, then the UE 202 may determine a default TA offset value of N_{TA,offset} for the serving cell. If the UE 202 is configured with two uplink carriers for a serving cell, a same TA offset value of N_{TA,offset} may apply to both carriers. Upon reception of a TA command for a TA group (TAG), the UE 202 may adjust uplink timing for physical uplink shared channel (PUSCH), sounding reference signal (SRS), and physical uplink control channel (PUCCH) transmissions on all the serving cells in the TAG based on a TA offset value of N_{TA,offset} that the UE 202 expects to be the same for all serving cells in the TAG and based on a received TA command, where the uplink timing for the PUSCH, SRS, and PUCCH transmissions is the same for all the serving cells in the TAG.

For a band with synchronous contiguous intra-band E-UTRA-NR dual connectivity (EN-DC) in a band combination with non-applicable maximum transmit timing difference requirements, if the UE 202 indicates ul-TimingAlignmentEUTRA-NR as ‘required,’ and the UE 202 determines uplink transmission timing based on a timing adjustment indication for a TAG from a MCG and a TAG from a SCG to be different, then the UE 202 may adjust the transmission timing for the PUSCH, SRS, or PUCCH transmission on all serving cells part of a band with the synchronous contiguous intra-band EN-DC based on a timing adjustment indication for a TAG from a serving cell in the MCG in the band. The UE 202 may not be expected to transmit a PUSCH, SRS, or PUCCH in one CG when the PUSCH, SRS, or PUCCH is overlapping in time, even partially, with a random access preamble transmitted in another CG.

For an SCS of 2^{μ}. 15 kHz, the TA command for a TAG may indicate a change of uplink timing relative to the current uplink timing for the TAG in multiples of 16·64·T_{c}/2^{μ}. A TA command in case of an RAR or in an absolute TA command MAC-CE, T_{A}, for a TAG indicates NTA values by index values of T_{A}=0, 1, 2, . . . , 3846, where an amount of the time alignment for the TAG with an SCS of 2^{μ}·15 kHz is N_{TA}=T_{A}·16·64/2^{μ}, where N_{TA} may be defined relative to the SCS of the first uplink transmission from the UE after the reception of the RAR or the absolute TA command MAC-CE. In some other cases, a TA command, T_{A}, for a TAG may indicate an adjustment of a current N_{TA} value, N_{TA} old, to a new N_{TA} value, N_{TA} new, by index values of T_{A}=0, 1, 2, . . . , 63, where for an SCS of 2^{μ}·15 KHZ, N_{TA} new=N_{TA} old+(T_{A}−31)·16·64/2^{μ}.

If a UE 202 has multiple active uplink bandwidth parts (BWPs) in a same TAG, including uplink BWPs in two uplink carriers of a serving cell, the TA command value may be relative to the largest SCS of the multiple active uplink BWPs. The applicable N_{TA_new} value for an uplink BWP with a lower SCS may be rounded to align with the TA granularity for the uplink BWP with the lower SCS while satisfying relevant TA accuracy requirements. Adjustment of an N_{TA} value by a positive or a negative amount may indicate an advancement or delay of the uplink transmission timing for the TAG by a corresponding amount, respectively.

For a TA command received on an uplink slot n and for a transmission other than a PUSCH scheduled by an RAR uplink grant or a fallbackRAR uplink grant, or a PUCCH with HARQ-ACK information in response to a successRAR, the corresponding adjustment of the uplink transmission timing applies from the beginning of an uplink slot n+k+1+2^{μ}·K_{offset}, where

$$k = ⌈ {N}_{slot}^{subframe , μ} \cdot ( {N}_{T , 1} + {N}_{T , 2} + {N}_{TA , max} + 0.5 ) / {T}_{sf} ⌉ ,$$

N_{T,1} may represent a time duration in milliseconds (ms) of N₁ symbols corresponding to a PDSCH processing time for UE processing capability 1 when an additional PDSCH demodulation reference signal (DMRS) is configured, N_{T,2} may represent a time duration in ms of N2 symbols corresponding to a PUSCH preparation time for UE processing capability 1, N_{TA,max} may represent a maximum TA value in ms that may be provided by a TA command field of 12 bits,

$${N}_{slot}^{subframe , μ}$$

may represent a number of slots per subframe, T_{sf} may represent a subframe duration of 1 ms, and K_{offset}=K_{cell,offset}−K_{UE,offset}, where K_{cell,offset} may be provided by cellSpecificKoffset and K_{UE,offset} may be provided by a differential K_{offset} MAC-CE command, otherwise, if not respectively provided, K_{cell,offset}=0 or K_{UE,offset}=0·N₁ and N₂ may be determined with respect to a minimum SCS among the SCSs of all configured uplink BWPs for all uplink carriers in the TAG and of all configured downlink BWPs for the corresponding downlink carriers. For μ=0, the UE assumes N_{1,0}=14. Slot n and

$${N}_{slot}^{subframe , μ}$$

may be determined with respect to a minimum SCS among the SCSs of all configured uplink BWPs for all uplink carriers in the TAG. N_{TA},max may be determined with respect to the minimum SCS among the SCSs of all configured uplink BWPs for all uplink carriers in the TAG and for all configured initial uplink BWPs provided by initialUplinkBWP. The uplink slot n may be the last slot among uplink slot(s) overlapping with slot(s) of PDSCH reception assuming T_{TA}=0, where the PDSCH may provide the TA command and T_{TA} is defined.

If a UE 202 changes an active uplink BWP between a time of a TA command reception and a time of applying a corresponding adjustment for the uplink transmission timing, the UE 202 may determine the TA command value based on the SCS of the new active uplink BWP. IF the UE 202 changes an active uplink BWP after applying an adjustment for the uplink transmission timing, the UE 202 may assume a same absolute TA command value before and after the active uplink BWO change. If the received downlink timing changes and is not compensated or is only partially compensated by the uplink timing adjustment without a TA command, then the UE may change N_{TA} accordingly. In some cases, if two adjacent slots overlap due to a TA command, the latter slot may be reduced in duration relative to the former slot. The UE may refrain from changing N_{TA} during an actual transmission time window for a PUSCH or a PUCCH transmission.

Using higher-layer ephemeris parameters for a serving satellite (e.g., the satellite 206), if provided, a UE 202 may pre-compensate a two-way transmission delay on the service link based on

$${N}_{TA , adj}^{UE} ,$$

which the UE 202 may determine using the serving satellite position and its own position. To pre-compensate the two-way transmission delay between the uplink time synchronization RP 208 and the satellite 206, the UE 202 may determine

$${N}_{TA , adj}^{common}$$

based on a one-way propagation delay, Delay_{common}(t), which the UE 202 may determine as

$${Delay}_{c o m m o n} ( t ) = \frac{{TA}_{C o m m o n}}{2} + \frac{{TA}_{CommonDrift}}{2} \times ( t - {t}_{epoch} ) + \frac{{TA}_{CommonDriftVariant}}{2} \times {( t - {t}_{epoch} )}^{2} ,$$

where TA_{Common}, TA_{CommonDrift}, and TAcommonDriftVariant may be respectively provided via ta-Common, ta-CommonDrift, and ta-CommonDriftVariant, and t_{epoch} may be provided by epochTime, which may represent an epoch time of ta-Common, ta-CommonDrift, and ta-CommonDriftVariant. The Delay_{common}(t) may provide a distance at time t between the serving satellite and the uplink time synchronization RP 208 divided by the speed of light. The uplink time synchronization RP 208 may be a point where the downlink and the uplink are frame aligned with an offset given by N_{TA,offset}.

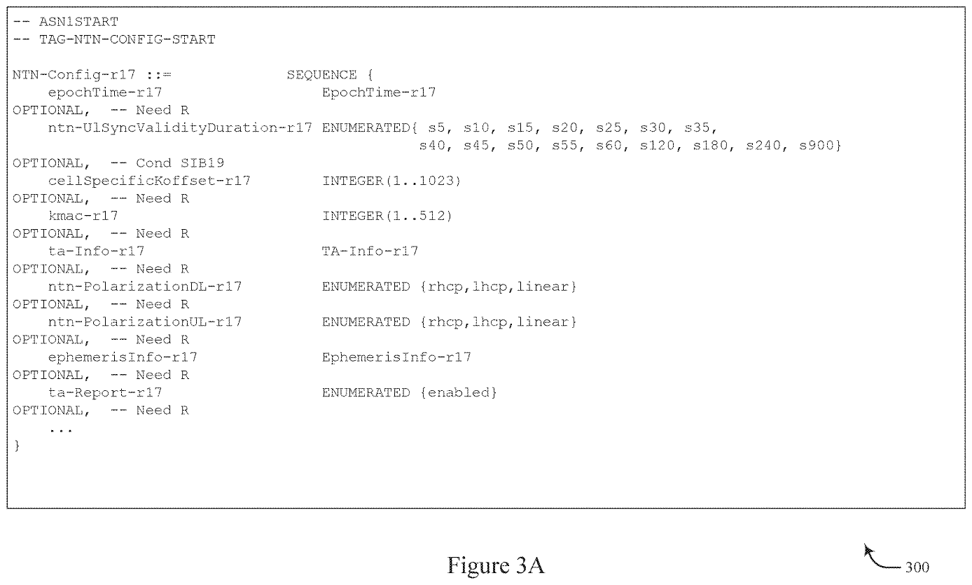

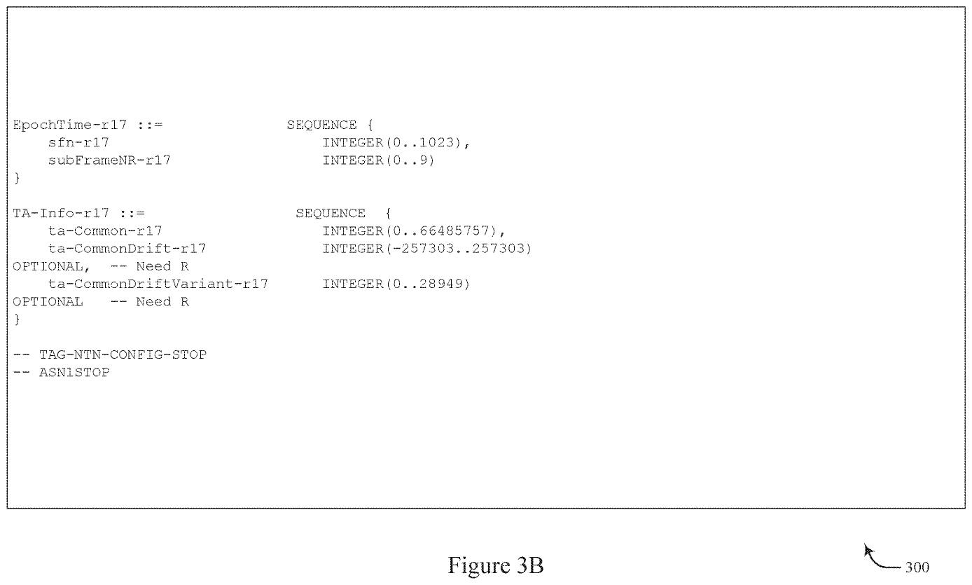

FIGS. 3A and 3B illustrate an example of an IE 300 in accordance with aspects of the present disclosure. The IE 300 may be an example of an NTN-Config IE for NTN configuration, which may include essential parameter information needed for calculation of a common TA and user-specific information.

The IE 300 may include various fields such as EphemerisInfo, epochTime, cellSpecificKoffset, Kmac, ntn-PolarizationDL, ntn-PolarizationUL, ntn-UlSyncValidityDuration, ta-Common, ta-CommonDrift, ta-CommonDriftVariant, and ta-Report, among others. The EphemerisInfo field may provide satellite ephemeris information either in a format of a position and velocity state vector or in a format of orbital parameters. This field may be excluded from the IE 300 when determining changes in system information (i.e., changes to the EphemerisInfo field should neither result in system information change notifications nor modifications of a value Tag field in a SIB1).

The epochTime field may indicate an epoch time for NTN assistance information. When explicitly provided through a SIB or dedicated signaling, a value of the epochTime field may be a starting time of a downlink subframe, indicated by a system frame number (SFN) and a subframe number signaled together with the NTN assistance information. For a serving cell, the field sfn may indicate a current SFN or a next upcoming SFN after the frame where the message indicating the epochTime field is received. For a neighbor cell, the sfn field may indicate an SFN nearest to the frame where the message indicating the epochTime field is received. The reference point for the value of the epochTime field of the serving NTN payload ephemeris and common TA parameters may be an uplink time synchronization reference point. If the epochTime field is absent from the IE 300, the epoch time may be the end of an SI window where a SIB19 is scheduled. The epochTime field may be mandatory present when provided via a dedicated configuration. If the epochTime field is absent in the IE 300 provided via NTN-NeighCellConfig, then the UE may use an epoch time of the serving cell. Otherwise, the epochTime field may be based on the timing of the serving cell (i.e., the SFN and the subframe number indicated in the epochTime field refers to the SEN and the subframe of the serving cell). In the case of handover or conditional handover, the epochTime field may be based on a timing of a target cell (i.e., the SFN and the subframe number indicated in the epochTime field may refer to an SFN and a subframe of the target cell). For the target cell, the UE may consider the epoch time, indicated by the SEN and the subframe number of the target cell, to be the frame nearest to the frame in which the message indicating the epochTime field is received. The epochTime field may be excluded when determining changes in system information (i.e., changes to epochTime may neither result in system information change notifications nor modifications of a value Tag field in a SIB1).

The cellSpecificKoffset field in the IE 300 may indicate a scheduling offset used for the timing relationships that are modified by an NTN. The unit of the cellSpecifickoffset field may be a number of slots for a given SCS of 15 kHz. If the cellSpecificKoffset field is absent from the IE 300, the UE may assume a value of 0. The Kmac field may represent a scheduling offset provided by an NE if downlink and uplink frame timing are out of alignment at the NE. The UE may use the Kmac field for UE action and assumption on downlink configurations indicated by a MAC-CE command via a PDSCH. If the Kmac field is absent from the IE 300, the UE may assume a value of 0. For the reference SCS value for the unit of Kmac in FR1, a value of 15 kHz may be used. The unit of Kmac may be a number of slots for a given SCS.

The ntn-PolarizationDL field, if present in the IE 300, may indicate polarization information for downlink transmission on a service link, including right hand circular polarization (RHCP), left hand circular polarization (LHCP), and linear polarization. The ntn-PolarizationUL field, if present in the IE 300, may indicate polarization information for an uplink service link. If the ntn-PolarizationUL field is not present in the IE 300 and the ntn-PolarizationDL field is present, then the UE may assume the same polarization for uplink and downlink.

The ntn-UlSyncValidityDuration field may indicate a validity duration configured by the NE for assistance information (i.e., serving and/or neighbor satellite ephemeris information and common TA parameters), which may indicate a maximum time duration (from epochTime) during which the UE may apply assistance information without having acquired new assistance information. The unit of the ntn-UlSyncValidityDuration field may be seconds. For example, a value s5 may correspond to 5 seconds, a value of s10 may correspond to 10 seconds, and so on. The ntn-UlSyncValidityDuration field may apply to both connected and idle mode UEs. If the ntn-UlSyncValidityDuration field is absent from the IE 300 provided via NTN-NeighCellConfig, then the UE may use a validity duration from serving cell assistance information. The ntn-UlSyncValidityDuration field may be excluded from the IE 300 when determining changes in system information (i.e., changes to the ntn-UlSyncValidityDuration field may neither result in system information change notifications nor modifications of a valueTag field in a SIB1). The ntn-UlSyncValidityDuration field may only be updated when at least one of the fields epochTime, ta-Info, or ephemerisInfo is updated.

The ta-Common field may indicate a network-controlled common TA value and may also include any timing offset considered necessary by the NE. The ta-Common field with a value of 0 is supported. The granularity of the value of the ta-Common field may be 4.072×10³ μs. Values of the ta-Common field may be given in a unit of corresponding granularity. The ta-Common field may be excluded from the IE 300 when determining changes in system information (i.e., changes of the ta-Common field may neither result in system information change notifications nor modifications of a valueTag field in a SIB1). The ta-CommonDrift field may indicate a drift rate of a common TA. The granularity of the value of the ta-CommonDrift field may be 0.2×10⁻⁴ μs/s². Values of the ta-CommonDrift field may be given in a unit of corresponding granularity. The ta-CommonDrift field may be excluded from the IE 300 when determining changes in system information (i.e., changes of the ta-CommonDrift field may neither result in system information change notifications nor modifications of a value Tag field in a SIB1). The ta-CommonDriftVariant field may indicate a drift rate variation of the common TA. The granularity of the value of the ta-CommonDriftVariant field may be 0.2×10⁻⁴ μs/s². Values of the ta-CommonDrift field may be given in a unit of corresponding granularity. The ta-CommonDrift field may be excluded from the IE 300 when determining changes in system information (i.e., changes of the ta-CommonDrift field may neither result in system information change notifications nor modifications of a value Tag field in a SIB1).

The ta-Report field, when included in SIB19, may indicate that reporting of a TA is enabled during random access due to an RRC connection establishment, RRC connection resume, and RRC connection reestablishment. When the ta-Report field is included in a ServingCellConfigCommon IE within dedicated signaling, the field may indicate that TA reporting is enabled during random access due to reconfiguration with sync.

In an NR NTN transparent payload architecture, a UE may pre-compensate a two-way transmission delay on a service link based on a TA calculation. The UE may determine (e.g., calculate, compute, identify) the TA using a location (i.e., position) of a serving satellite and a location (i.e., position) of the UE. For this purpose, the UE may use an open loop timing adjustment procedure to determine the TA, which may be given as

$${T}_{TA} = ( {N}_{TA} + {N}_{T A , offset} + {N}_{TA , adj}^{c o m m o n} + {N}_{TA , adj}^{UB} ) {T}_{s} .$$

N_{TA} may represent a TA component based on accumulating TA command received from an NE (e.g., by a MAC-CE command) and may be reset to zero when the UE performs a RACH procedure to acquire TA estimates, and

$${N}_{TA , adj}^{UE}$$

may represent a TA component specific to satellite communications. The UE may determine

$${N}_{TA , adj}^{UE}$$

based on the UE's own location and a service satellite's ephemeris data, so the accuracy of

$${N}_{TA , adj}^{UE}$$

may depend on the accuracy of the UE and satellite location information.

A UE in an NR NTN may have GNSS capabilities. That is, the UE may be capable of calculating (e.g., determining, computing) its own location using GNSS. However, GNSS may be prone to spoofing, which may either lead to incorrect location reporting and potential denial of service on a temporary basis (e.g., for the period of the spoofing), or jamming, which may lead to denial of service on a temporary basis (e.g., for the period of the jamming). Additionally, natural phenomena, such as solar radiation bursts that may affect large parts of the earth's surface for ten to twenty minutes, may also result in temporary unavailability of GNSS signals, resulting in a denial of service for the UE.

To address such issues, the described techniques support time and frequency synchronization when GNSS is temporarily unavailable. Specifically, an NE may provide (e.g., transmit, indicate, signal) a set of parameters related to time and frequency pre-compensation to the UE, which may provide an initial coarse synchronization which the UE may use to perform a RACH transmission. The coarse synchronization may increase changes of RACH detection by the NE. In some examples, the set of parameters may be associated with a zone. In such cases, the UE may use parameters associated with a cell as baseline parameters common to all UEs in the cell, where differential values may be associated with specific zones so the UE may apply a combination of baseline and zone-specific parameters.

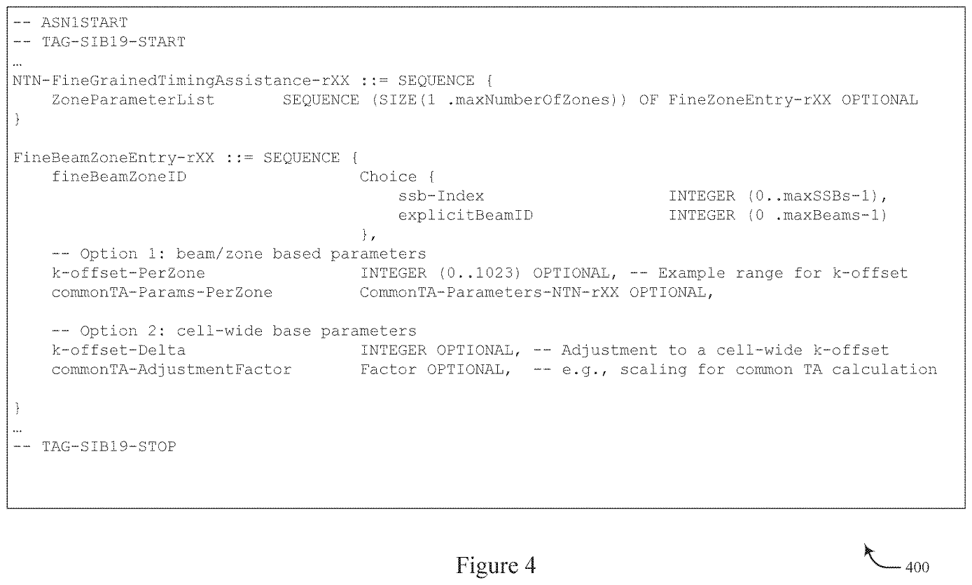

FIG. 4 illustrates an example of an IE 400 in accordance with aspects of the present disclosure. The IE 400 may be an example of a SIB19 IE, which may include zone-based network assistance timing parameters (e.g., time and frequency synchronization parameters).

As described herein, an NE may provide (e.g., transmit, indicate, signal) a set of parameters related to time and frequency pre-compensation to the UE, which may provide an initial coarse synchronization which the UE may use to perform a RACH transmission. In some examples, the NE may indicate the set of parameters via cell-based common assistance information. For example, the NE may broadcast coarse timing and frequency assistance information for a cell as part of SIB (e.g., SIB 19 for an NTN). That is, the UE may receive assistance information that is applicable to a coverage area and includes a set of baseline synchronization correction parameters.

After a UE has detected SSBs and decoded a corresponding PSS, SSS, or PBCH, the UE may use the assistance information to perform a coarse (or finer, in some cases) uplink timing and frequency synchronization to perform a RACH procedure. The assistance information broadcasted by the NE may include various information, such as the set of baseline synchronization correction parameters. For example, the assistance information may include at least one of a cell-specific TA value catering for RTT (e.g., including service and feeder link delay), a cell-specific TA value with TA drift rate(s), a validity duration of the cell-specific TA value and drift rates, scheduling offsets of the cell that is already part of the SIB 19 but is modified with higher values for the GNSS-independent case described herein, an expected range of propagation delays and timing error tolerances, a cell-specific initial frequency compensation value, or a validity duration of the cell-specific frequency compensation value. The cell-specific TA value with TA drift rate(s) may indicate a rate of change of the TA such that the UE may adjust its timing to counter satellite movement, allowing the UE to maintain synchronization over time without performing frequent RACH updates. A TA drift rate may be of a single order or include higher orders to compensate for satellite movement.

Based on the GNSS (e.g., a GNSS location or position fix) being unavailable for the UE, the UE may select a baseline synchronization correction parameter from the set of baseline synchronization correction parameters. The UE may apply the selected baseline synchronization correction parameter to a corresponding baseline time and frequency synchronization parameter to calculate an initial uplink pre-compensation value. The UE may use the initial uplink pre-compensation value when transmitting an uplink signal for initial access (e.g. a RACH transmission).

In some implementations, the NE may divide its large NTN coverage area into multiple smaller, distinct cells. Each cell may broadcast its own unique physical cell identifier (PCI), where, for each cell, the NE may associate a set of timing and frequency synchronization parameters in the assistance information with each PCI. The NE may broadcast not only cell-based time and frequency synchronization parameters but may also include neighboring cell time and frequency synchronization parameters in the same broadcast message coupled with each PCI index. Specifically, the coverage area of a satellite in an NTN may be divided into finer cells. For example, each cell may be associated with one beam and a unique PCI. In some implementations, there may be a one-to-one mapping of SSBs and PCI identifiers. The UE may perform a cell search and detect an SSB. From the PSS or SSS in that SSB, the UE may derive a corresponding PCI. Then, the UE may read the SIBs broadcast by the NE with the PCI. Such SIBs may include the assistance information including the time and frequency synchronization parameters, which may be for UEs in the cell. In some examples, the assistance information may also include time and frequency synchronization parameters for the neighboring cell to assist UEs that are located close to or at the edge of two cells. The UE may calculate (e.g., determine, compute) and apply a TA and a frequency pre-compensation value when transmitting a RACH.

Additionally, or alternatively, the NE may indicate the set of parameters via zone-specific assistance information (i.e., zone/beam-based common assistance information). In such cases, the NE may divide the coverage area of a cell into smaller zones. Each zone may be associated with an SSB beam. The set of parameters may include coarse time and frequency synchronization parameters to compensate for a UE-specific propagation delay that may not be calculated due to the inability for the UE to estimate its own location (e.g., the unavailability of GNSS). The association of the time and frequency synchronization parameters with zones or beams of a cell may be beneficial in reducing timing and frequency errors as NTN cells may be relatively large, and the UE at different locations within the cell may experience different timing variations based on the UE locations and satellite movement. That is, the UE may receive the zone-specific assistance information (e.g., second assistance information), which may include a set of zone identifiers, each zone identifier associated with a zone of the cell and at least one zone-specific synchronization correction parameter. The UE may select a zone identifier from the set based on a coarse location of the UE and calculate the initial uplink pre-compensation value by applying a zone-specific synchronization correction parameter associated with the selected zone identifier to the baseline time and frequency synchronization parameter. In some cases, to determine the coarse location of the UE, the UE may retrieve a previously stored location of the UE from the UE memory. Additionally, or alternatively, the UE may determine its coarse location based on a cell identifier of a last-connected terrestrial network.

In some examples, the UE may receive the common and zone-specific assistance information via one or more SIBs, such as the SIB 19 depicted in the IE 400. If the coarse location of the UE does not correspond to a zone identifier in the zone-specific assistance information (i.e., if the set of zone identifiers excludes the coarse location of the UE), the UE may calculate the initial uplink pre-compensation value based solely on the common assistance information. In some cases, the UE may transmit capability information that indicates support for synchronization in the NTN, where one or more of the assistance information or the second assistance information is received based on the transmitted capability information.

In some implementations, the zone-specific assistance information may include a mapping of geographic regions within a satellite beam to corresponding synchronization correction parameters. For example, the NE may divide the cell into smaller, identifiable sub-regions by creating multiple narrow spot beams within a larger coverage area of the cell. In such cases, the NE may define an identifier for each of the sub-regions and provide more tailored initial timing assistance for each of the sub-regions. Each zone identifier in the zone-specific assistance information may correspond to a distinct portion of a satellite beam footprint. In some cases, for quasi-Earth-fixed cells, the cell coverage may be fixed even if the satellite is moving. The cell may be divided into different geographical zones on Earth with each zone having a distinct set of time and frequency synchronization parameters. In some other cases, the NE may define the zones based on SSB sweep areas that may be identifiable by SSB timing or associated indices. As SSB beams sweet across an area of a cell, different parts of the sweep cycle may be treated as different zones with slightly different average propagation characteristics.

In some implementations, a zone-specific synchronization correction parameter may be determined or calculated for a reference point within a zone. For example, the reference point for baseline synchronization correction parameters may be a center of a coverage area of the NE, where a reference point for a zone-specific synchronization correction parameter may be a center of the zone. In some examples, the NE may define the zones based on some gematrical relation (e.g., relative to a beam or cell center). In such cases, the NE may indicate a definition of the zone type to the UE. For example, the NE may define zones based on concentric rings, where the cell may be divided into annular regions around the cell center, thus mapping the increasing propagation delay as the UE moves outwards. By way of another example, the cell area may be overlaid with a virtual grid, where each grid cell or group of grid cells may form a zone. In some examples, the NE may require a coarse location of the UE to identify such zones. Additionally, such zone distribution may yield improved timing corrections at the UE.

In some examples, the NE may define the zones based on signal strength contours (i.e., if a beam has a predictable power roll-off, different zones may be roughly associated with ranges of received signal strength (i.e., reference signal received power (RSRP)). For example, Zone 1 (i.e., the center of the cell) may have a high RSRP, Zone 2 (i.e., the middle of the cell) may have a medium RSRP, and Zone 3 (e.g., the edge of the cell) may have a low RSRP. Such zone distribution may be a simple heuristic for the UE, where the UE may implicitly know in which zone the UE is located based on signal strength.

In some implementations, the NE may indicate a set of time and frequency synchronization parameters for each zone, where the NE may pre-calculate (e.g., pre-determine, pre-compute) the parameters based on previous knowledge or artificial intelligence (AI)/machine learning (ML)-based prediction. Using zone-specific time and frequency synchronization parameters may minimize average or worst-case residual timing errors for UEs located within a particular zone when the UE performs initial TA calculations.

In some examples, zone-specific assistance information (i.e., second assistance information) may include various zone-specific time and frequency synchronization parameters. For example, the zone-specific time and frequency synchronization parameters may include at least one of a zone identifier, a zone or cell-specific default TA value, a differential TA value, a specific K_{offset} value for the zone, a parameter that indicates when such zone-based information was generated, a parameter describing a rate of change of propagation delay, a zone or beam-based initial frequency offset value, a Doppler drift rate, or a reference location. The zone identifier may be some index defining that the time and frequency synchronization parameters in the zone-specific assistance information are valid for a configured zone. The zone or cell-specific default (e.g., initial, base) TA value may be an estimate of a total round-trip delay (covering both a feeder link delay and an average or zone-center service link delay) that a UE within a specific zone may use for the UE's first attempt to contact the NE. The NE may continuously update the default TA value based on a current position of the satellite and beam pointing. In contrast to a feeder link TA common value, which is broadcasted, the default TA value may be an NE-calculated (e.g., determined, computed), frequency updated estimated TA for an average UE in the zone. Using the default TA value may reduce the burden on a UE to estimate a full-service link delay without GNSS. The default TA value may be cell-based or zone-based depending on applicable scenarios. For example, a default TA value that is cell-based may be applicable to all UEs in the cell. Alternatively, if the default TA value is zone-based, the NE may broadcast different zone-specific default TA values to UEs in different zones of the cell and the UE may detect SSBs accordingly.

The differential TA value (i.e., a delta TA value) may be configured for each zone in the cell, whereas a default or initial TA value may be cell-based. For a particular zone, the UE may calculate (e.g., determine, compute) an initial uplink TA, which may be a summation of the initial cell-based TA value and the differential TA value. The specific K_{offset} value for the zone or beam may define a crucial timing offset value for adjusting the UE's uplink transmission timing relative to a downlink timing reference. The K_{offset} value may be specifically designed to help manage large RTTs in an NTN by enabling the UE to transmit earlier by a pre-configured amount of time. The parameter that indicates when such zone-based information was generated may be a time stamp for each zone or for how long the information is considered value. For example, the parameter may be a validity duration indicating a validity of an initial or differential TA. Such a parameter may be crucial for low earth orbit (LEO) and medium earth orbit (MEO) satellites and beams that are moving, as the relationship between geographic zones and TA values may change constantly. If the SIB (i.e., common or zone-specific assistance information) includes a validity timer, the UE may initiate the validity timer and refrain from using the corresponding common assistance information if an age of the common assistance information exceeds a duration of the validity timer (e.g., if the common assistance information is out of date or inaccurate).

The parameter describing the rate of change of the propagation delay may describe a satellite's motion relative to a current zone (e.g., in microseconds (μ) per second(s)). A UE may use such a rate of change, in some cases in conjunction with its own measurements of downlink signal arrival drift) to make short-term predictions and adjustments to its TA, even without knowing its absolute position or performing a full orbital calculation. The zone or beam-based initial frequency offset value may be an initial Doppler value (e.g., in Hz), which the UE may use within a zone or beam to compensate for frequency errors. Similar to the default or initial TA value, the UE may continuously update the initial frequency offset value based on a current position of the satellite and beam pointing.

The Doppler drift rate may be configured by the NE to compensate for changing satellite position. As the satellite rises over the horizon, the satellite's line-of-sight velocity relative to UE position may change continuously, which in turn may cause the Doppler shift to change every second. By signaling the Doppler drift rate, the NE may indicate to the UE how many Hz the Doppler shift will likely change when the NE receives the signal. The reference location may be configured by the NE for the default or initial TA value and the initial Doppler value. If configured, the UE may use the reference location as its own location for the purpose of calculating the TA and Doppler for the UE. In such cases, the UE may use the open loop timing adjustment procedure described herein by using the reference location as the location of the UE. In some cases, the NE may use the center of the zone as the reference location, which may significantly reduce frequency errors.

In the example of the IE 400, a SIB19 IE may include time and frequency synchronization parameters, including zone or beam-based time and frequency synchronization parameters (e.g., k-offset-PerZone, commonTA-Params-PerZone) and cell-wide baseline time and frequency synchronization parameters (e.g., k-offset-Delta, commonTA-AdjustmentFactor).

Additionally, or alternatively, the NE may provide (e.g., transmit, indicate, signal), a reference time indication to the UE to mitigate timing mismatch. When GNSS is unavailable, UE clock alignment may not work (e.g., using SIB9). In NTN, this problem may become severe as slight misaligned clocks may result in significant timing errors. As such, the NE may indicate a timing reference, such as an NRT, to the UE to assist the UE in synchronizing its internal clock with the NE. The NRT may be a coarse timing compensation that provides a starting point to enable timing calculations for UEs without GNSS or with GNSS location estimates with lower accuracy. In some examples, the NRT may be a timestamp that indicates when a satellite transmitted a signal based on a synchronized clock at the NE. The NRT may assist UEs in the absence of GNSS to estimate propagation delays and synchronize their transmissions, particularly for UEs performing initial access. NRT may enable UEs to calculate the propagation delay between the UEs and the satellite, compensating for the large distances involved (e.g., starting from 600 km for LEO satellites to 35,000 km for GEO satellites).

In some implementations, the NRT may be directly tied to (e.g., may directly correspond to) a satellite's clock. Alternatively, the NRT may be directly tied to (e.g., may directly correspond to) a global reference time system, such as Coordinated Universal Time (UTC). Alternatively, the NRT may be directly tied to (e.g., may directly correspond to) a synchronized ground station time (e.g., UTC adjusted for a position of a satellite). For example, in the case of transparent payload architectures, ground NEs (e.g., gNBs) may be synchronized (e.g., via terrestrial links). The ground NEs may forward a synchronized time to one or more UEs as an NRT. In the case of regenerative payloads, the satellite may have an onboard atomic clock and act as a time master. In such cases, the satellite time may be used at the NRT for internal clock synchronization.

In some examples, the NRT may correspond to a specific frame reference, which may indicate, to the UE, a transmission instance of PSS, SSS, or PBCH signals to that specific frame reference. As such, the NRT may implicitly indicate a precise transmission schedule from the perspective of the satellite. In some implementations, the NE may transmit the NRT periodically as part of a SIB (e.g., NTN SIB19). In such cases, at least one parameter may be included in the SIB for the NRT, for example a timestamp indicating when a signal was sent. The SIB may also include information such as satellite ephemeris data and common TA parameters to assist the UE with estimating feeder link delays. In such cases, the UE may apply a zone-specific synchronization correction parameter based on the satellite ephemeris data. After decoding a SIB, the UE may calculate a one-way propagation delay using the NRT and roughly align the UE's clock with the NE's clock by adjusting the propagation delay accordingly.

Specifically, to use the NRT to align the UE and NE clocks when GNSS is unavailable, the UE may achieve coarse time and frequency synchronization by utilizing techniques such as a wider window search for SSB. Based on decoding a master information block (MIB) from a PBCH, the UE may identify an SFM and the location of a SIB1. Then, the UE may decode the SIBI to identify scheduling information for other SIBs, including SIB19, which may include NTN-specific data such as satellite ephemeris data, a common TA, Doppler estimates, an NRT, and so forth. The UE may extract (e.g., decode, determine, identify) timing information from the NRT, T_{NRT}, which may indicate a transmission time of a signal transmitted from a satellite based on the NE's synchronized clock. Using T_{NRT}, the NE may calculate

$${t}_{UE}^{n o w} - {T}_{NRT} = {Δ}_{prop} + {Δ}_{clk , UE} , where {t}_{UE}^{n o w}$$

may represent a current time local at the UE, and Δₚᵣₒₚ may represent a propagation delay (half RTT). Because the propagation delay may be known as

$${Δ}_{p r o p} \approx \frac{1}{2} \overline{TA}$$

from the SIB 19, the UE may directly infer its own clock offset, Δ_{clk,UE}, as

$${Δ}_{clk , UE} = ( {t}_{UB}^{now} - {T}_{NRT} ) - \frac{1}{2} \overline{TA} .$$

In doing so, the UE may shift its local time by −Δ_{clk,UE} and thereafter use its own crystal to maintain alignment. After adjusting its clock error, the UE may advance its uplink transmission by the propagation delay (e.g., twice the one-way propagation delay to compensate for RRT) to ensure signals arrive at the satellite within a correct timing window. This may compensate for large NTN delays.

In some implementations, the NRT may define a system time that is adjusted for feeder link clock errors (e.g., the clock mismatch between the satellite and the NE on the ground). The NE may compute such errors and adjust a value of the NRT accordingly to account for the mismatch. Additionally, or alternatively, the UE may calculate a Doppler drift by comparing the NRT timestamps for every periodic SIB, since the NRT timestamps may be more frequent. For example, if NRT timestamps may come fresh for each SIB (e.g., every 80 ms), the UE may compute T_{NRT}(tₖ₊₁)−T_{NRT}(tₖ) and compare to its local clock advance. Any residual value may be pure Doppler drift, for which the UE may continuously compensate.

In some implementations, the UE may employ such NRT-based correction when GNSS is unavailable if the UE cannot use other methods, such as SIB 9 for Global Positioning System (GPS) clock synchronization. In some cases, the NE may set priority rules for when the UE may use NRT-based clock adjustment. For example, the UE may always use SIB 9-based clock synchronization as a priority when GNSS, NRT, and SIB 9 are available. Additionally, or alternatively, when GNSS is unavailable but NRT and SIB9 are available, the UE may use NRT-based clock synchronization as a priority. Additionally, or alternatively, when a UE uses NRT-based clock synchronization during initial access and is in a connected mode, the NE may indicate to the UE to further synchronize the NE and UE clocks in case GNSS becomes available. For example, the UE may indicate to the NE that GNSS is available, and the NE may further indicate to synchronize its clock errors based on SIB 9. Additionally, or alternatively, when a UE uses NRT-based clock synchronization during initial access and is in a connected mode, the UE may always adjust its clock errors when GNSS becomes available and SIB 9 is also available, without any explicit indication from the NE.

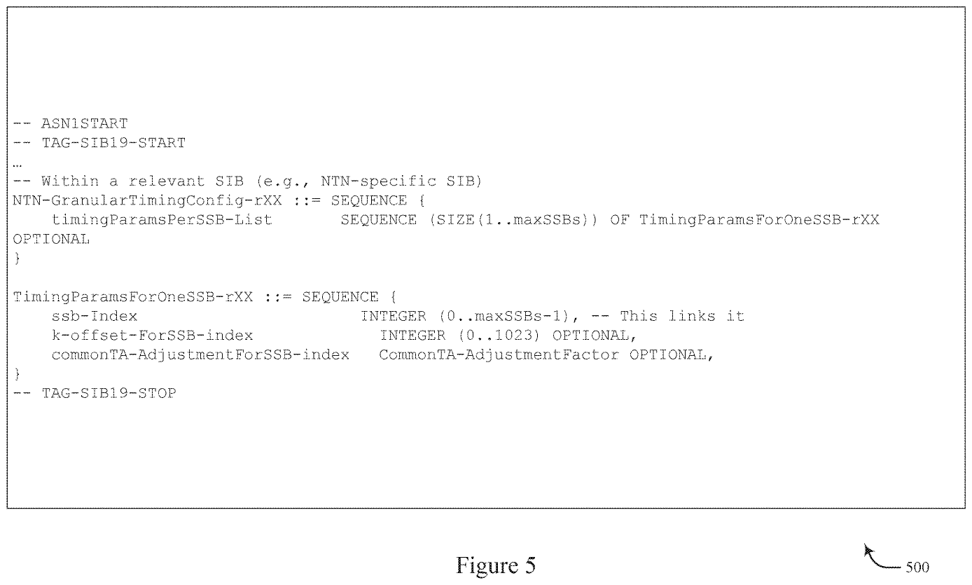

FIG. 5 illustrates an example of an IE 500 in accordance with aspects of the present disclosure. The IE 500 may be an example of a SIB19 IE, which may include SSB-based network assistance timing parameters (e.g., time and frequency synchronization parameters).

In some implementations, to distinguish reference timing parameters to a UE without GNSS, the NE may utilize a one-to-one mapping between an SSB index and a defined finer beam or zone. For instance, a zone may be implicitly defined by a primary coverage area of a specific SSB beam (e.g., SSB Index 0 represents Zone 0, SSB Index 1 represents Zone 1, and so on). When a UE performs an initial cell search, the UE may detect one or more SSBs. The UE may select an SSB with a highest RSRP, and the index corresponding to the selected SSB may become an identifier for the UE's current finer beam or zone. A SIB, such as the SIB19 IE in the IE 500, may indicate a set of timing parameters (e.g., time synchronization parameters), where each set of timing parameters may be explicitly linked to (e.g., associated with) an SSB index. The UE may use the set of timing parameters associated with the SSB index of the selected SSB. In the example of FIG. 5, the IE 500 may include a field timingParamsPerSSB-List, which may indicate the set of timing parameters associated with specific SSBs, where the field TimingParamsForOneSSB may indicate values such as ssb-Index, k-offset-ForSSB-index, and commonTA-AdjustmentForSSB-index for a particular SSB index.

In some implementations, there may be multiple SSBs within a zone with different offset values, or there may be multiple zones with one SSB index. If there are multiple SSBs within a zone, the NE may either configure some coarse parameters corresponding to each zone, where finer timing parameters may be configured for an SSB index. The UE may select a strongest SSB, identify a zone (e.g., from a zone index) and SSB index corresponding to the SSB, and use the corresponding parameters accordingly.

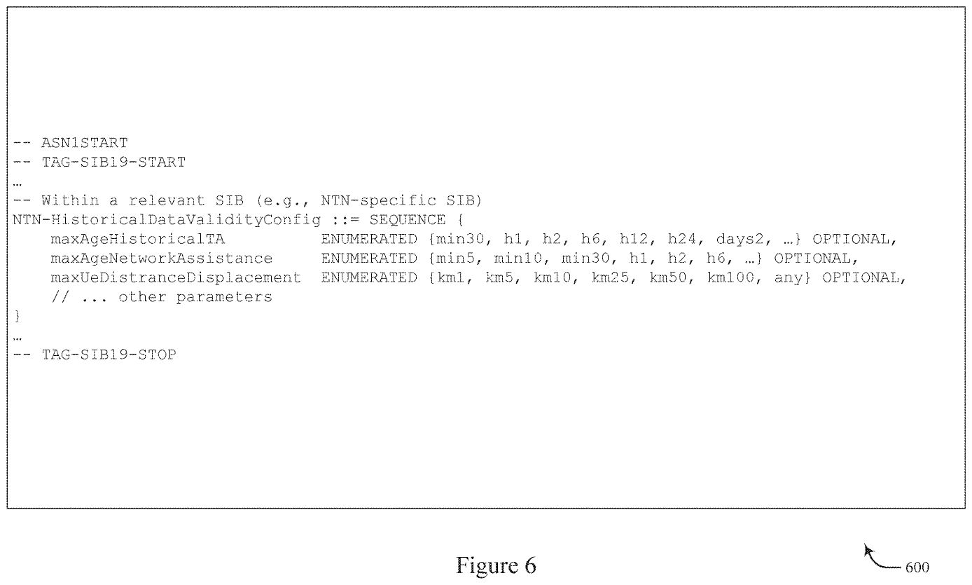

FIG. 6 illustrates an example of an IE 600 in accordance with aspects of the present disclosure. The IE 600 may be an example of a SIB IE with validity information of historical storage data. When GNSS is unavailable, the UE may use historical synchronization information (e.g., historical timing information parameters), such as the validity information in the IE 600 for the purpose of time and frequency synchronization during initial access to align its transmission timing with an NE.

As described herein, the UE may initiate a first communication session with a first NTN node. The first communication session corresponds to a first timestamp. The UE may initiate a second communication session with a second NTN node at a time subsequent to the first communication session, where the UE lacks a real-time GNSS location (e.g., GNSS is unavailable or inaccurate) at a second timestamp corresponding to the second communication session. The UE may estimate an initial TA value and an initial frequency pre-compensation value for the second communication session based on historical synchronization information, which includes a set of time and frequency synchronization parameters and the first timestamp. The UE may apply the initial TA value and the initial frequency pre-compensation value to an uplink transmission for initiating the second communication session.

In some examples when GNSS is unavailable, the UE may use an initial TA and an initial Doppler value to compensate for a propagation delay and satellite movement. The historical synchronization information may include at least one of past TA values from previous connections, past Doppler values, timestamps indicating when the past TA values and the past Doppler values were obtained, satellite identifiers linking the past TA values and the past Doppler values to specific satellites, a validity duration (e.g., by a parameter historicalTA-ValidityTimer), which may indicate a maximum duration for which a stored TA value may remain valid, a validity duration (e.g., by a parameter historicalDoppler-ValidityTimer, which may indicate a maximum duration for which a stored Doppler value may remain valid, a TA drift rate, which may indicate a satellite velocity or beam-specific TA drift rate (e.g., ±20 μs/s for LEO satellites) for UE extrapolation, a Doppler drift rate such as a satellite Doppler drift rate, which may be associated with a satellite orbit, previous UE locations (e.g., positions) with timestamps, a fallback time period for validity if no NE signaling is received to prevent UEs from using excessively old data, or a coarse location of the UE.

In some implementations, the UE may store (e.g., in a memory) historical synchronization information that includes TA values and frequency offset values. The frequency offset values may be used for NTN applications because of the Doppler effect, which may arise from the relative motion between the UE and a satellite, shifting the signal frequency. When initiating a new connection, the UE may retrieve historical TA and frequency offset values from the historical synchronization information that are associated with a target satellite. The UE may use the satellite's ephemeris data, which may detail the satellite's position and velocity, to adjust the TA and frequency offset values to account for any changes in the satellite's motion since the TA and frequency offset values were recorded. The UE may apply the adjusted TA and frequency offset values to a random access preamble transmission, pre-compensating for timing and Doppler shifts to align the UE's uplink frequency with expectations of the satellite, thus boosting changes of successful detection. For example, using historical frequency offset values included in the historical synchronization information and adjusted by satellite ephemeris data, the UE may estimate an initial frequency offset and apply the initial frequency offset to a random access preamble.

In some examples, the UE may store TA and frequency offset values for multiple satellites, each satellite corresponding to a unique satellite identifier. This may allow the UE to track past connections across an NTN constellation, which may be helpful for managing handovers between fast-moving LEO satellites. When initiating a connection, the UE may receive broadcast information indicating an identifier of a current satellite. Based on the identifier, the UE may select historical TA and frequency offset values from the historical synchronization information that correspond to the identifier. Using such a satellite-specific approach may ensure that the UE's initial TA estimate reflects the unique orbital traits and coverage of the satellite, improving accuracy of communications between the UE and the satellite without real-time GNSS data.

In some cases, the NE may broadcast a TA drift rate in a SIB, where the TA drift rate may indicate how a TA changes over time due to a satellite's motion. The TA drift rate may be useful for LEO satellites, which move quickly relative to Earth, causing continuous shifts in propagation delay. When estimating an initial TA without GNSS, the UE may apply the TA drift rate to a historical TA value from the historical synchronization information, adjusting the historical TA value based on the time elapsed since the historical TA value was recorded. That is, the UE may adjust a previously used TA value and a previously used frequency pre-compensation value based on a change in propagation delay and a change in Doppler shift between the first and second timestamps corresponding to the first and second communication sessions. For instance, if the satellite moves farther away from the UE, the TA value may increase, and the UE may account for the shift accordingly. Such adjustments may refine the historical TA value to match the satellite's current position, enhancing the precision of the initial TA estimate for the random access preamble transmission.

In some cases, the UE may receive broadcast information from one or more second NTN nodes that includes at least a common TA value. The UE may combine the adjusted previously used TA value with the common TA value to estimate the initial TA. Additionally, the UE may store one or more previously used TA values for one or more satellites and select a previously used TA value and a frequency pre-compensation value corresponding to a satellite identifier indicated in the broadcast information. Additionally, the UE may apply a drift rate adjustment to the previously used TA value based on a TA drift rate included in the broadcast information.

In some cases, the UE may analyze the historical synchronization information to evaluate success rates of post random-access attempts, noting whether single transmissions succeeded or if repetitions were needed. Using the historical synchronization information, the UE may determine an optimal repetition factor for the current random access preamble transmission. That is, the UE may determine a repetition factor for a random access preamble transmission based on prior connection success rates using the historical synchronization information. For example, if historical trends show frequent failures with single attempts (e.g., due to timing issues or weak signals), the UE may transmit the random access preamble multiple times within on random access occasion or across several random access occasions. This adaptive strategy may balance resource use with the need for a reliable connection, allow the UE to dynamically adjust transmissions to NTN challenges based on past performance, and improve rates of successful connections without wasting resources.

In some implementations, the NE may configure the UE with some parameters either during initial access, when the UE was previously in an RRC connected mode or state, or when the UE is in an RRC inactive or idle mode or state. For example, the NE may configure the UE with information about a validity duration of stored TA values based on satellite movement or UE movement. In some examples, the NE may use broadcast signaling or dedicated RRC signaling when the UE is in an RRC inactive, idle, or connected state to indicate to the UE to store the historical synchronization information including the time and frequency synchronization parameters. Additionally, or alternatively, the NE may indicate which set of parameters from the historical synchronization information the UE may store in case of GNSS unavailability.

Additionally, or alternatively, when GNSS is unavailable or when the accuracy of GNSS is very low, the NE may explicitly or implicitly indicate the use of stored time and frequency parameters to the UE during initial access or when the UE is in an RRC connected mode. For example, the NE may indicate, using a SIB, the use of historical TA values and historical Doppler values and ephemeris data for the UE to compute an initial TA. In such cases, the historical synchronization information may include an identifier of the first NTN node and satellite ephemeris data valid at the first timestamp corresponding to a communication session with the first NTN node. In some implementations, using the satellite ephemeris data, the UE may calculate first and second positions of the first and second NTN nodes at the first and second timestamps, respectively. Based on the positions of the NTN nodes relative to a coarse location of the UE, the UE may determine a difference in RTT. In some examples, the NE may use a flag to validate the relevance of the historical synchronization information, for example, based on an elapsed time or an estimated mobility. In some implementations, the UE may transmit a capability indication of the UE's support for storing and utilizing the historical synchronization information for time and frequency synchronization assistance (e.g., ntn-InitialAccessTimingHistorySupport-rxx as an optional UE feature).

In some implementations, the NE may define and configure a set of rules for validity, expiry, and updating of the historical synchronization information. The set of rules may be use for time and frequency synchronization during initial access or when the UE is in a connected mode without the use of GNSS to estimate the UE's own location. For example, the set of rules may include a rule about UE displacement, which may provide that data (e.g., a TA value) is only considered valid if the UE's estimated current course location is within a particular radius of the coarse location stored with the historical synchronization information. The NE may configure a maximum displacement radius. An acceptable displacement may depend on an NTN beam size and TA/Doppler sensitivity to UE location. The UE may still estimate its coarse self-displacement even if GNSS is unavailable, for example, using inertial sensors, last known terrestrial cell changes, or a user confirmation if stationary. The NE may also configure a default maximum displacement as a fallback mechanism, if nothing is otherwise configured. In this way, prior to estimating the initial TA value and the initial frequency pre-compensation value, the UE may determine that a time elapsed between the first timestamp and the second timestamp is less than a time threshold and determine that an estimated displacement of the UE between the first timestamp and the second timestamp is less than a displacement threshold (e.g., the maximum displacement). In such examples, the NE may indicate the time and displacement thresholds via broadcast system information (e.g., a SIB).

Additionally, or alternatively, if historical synchronization information is associated with a specific satellite identifier, the NE may define a rule or configure a parameter to indicate whether the historical synchronization information is only valid for a predicted satellite that is currently in view or of the historical synchronization information may be applied to any satellite identifier. The NE may also define that the use of the historical synchronization information may be associated with any satellite identifier but with the same ephemeris data, as multiple satellites may use a same trajectory in orbit.

Additionally, or alternatively, the NE may establish a rule for a validity period, for example, if the historical synchronization information fails any validity check (e.g., time, displacement), which may imply that the information is effectively expired for a current access attempt. Additionally, or alternatively, the NE may define explicit deletion timers for data storage. In some cases, the NE may define a timer that indicates when some of the historical synchronization information needs to be permanently deleted from UE storage after a longer, overarching expiry period, regardless of validity for a specific attempt. For example, the NE may specify or signal a maximum retention period for the historical synchronization information, which may prevent indefinite accumulation of data.

Additionally, or alternatively, the NE may establish a rule regarding repeated failures for a set of data. In some cases, this may include the network indicating a parameter or rule defining the reliability of the historical synchronization information. For instance, if initial access attempts using specific historical synchronization information consistently fail (e.g., for N consecutive failures), that specific historical synchronization information may be marked or flagged as unreliable and potentially expired or given a very low priority. The NE may configure the number of failures (N) as part of signaling, or the number of failures may be a fixed number when defining the rules for storage of the historical synchronization information.

Additionally, or alternatively, the NE may define a rule related to UE behavior upon successful initial access. For example, the NE may define an implicit primary update trigger of historical synchronization information upon successful completion of initial success. This may imply that after any successful initial access (whether aided by historical synchronization information or not), the UE may update its stored historical synchronization information with the parameters of the current successful access (e.g., a new TA, a new Doppler satellite identifier, a timestamp, a current coarse location, and so forth). In some examples, the UE may update the historical synchronization information with an updated TA value, an updated frequency pre-compensation value, and an updated second timestamp corresponding to the second communication session with the second NTN node based on successfully establishing the connection.

Additionally, or alternatively, the NE may establish a rule relating to the reception of updated assistance information. The NE may devise a signaling mechanism to provide updated assistance information (e.g., SIBs or RRC messages after successful initial access). For instance, if the UE receives new or updated timing assistance information from the NE (e.g., via SIBs or dedicated RRC messages), the UE may update or replace its relevant stored NE-derived assistance information. Additionally, or alternatively, the NE may define a rule related to periodic checking or refreshing of historical synchronization information if the UE is in coverage. For example, the NE may devise a SIB mechanism and UE idle mode procedures for UEs in an idle or inactive mode to incorporate timing related parameters either for updating the historical synchronization information or assisting in providing timing information. This implies that an idle UE in NTN coverage may periodically check for updated timing assistance SIBs to keep its network-derived assistance information updated (e.g., fresh), even if the UE is not immediately performing initial access.

In some implementations, the NE may broadcast a set of parameters related to storage of historical synchronization information as part of a SIB (e.g., in SIB 19 or a new SIB), such as the SIB in the IE 600. The set of parameters may be valid to UEs in a cell or to multiple cells in a satellite's footprint that are performing initial access without GNSS. Additionally, the set of parameters may define validity, expiry, and updating of the historical synchronization information that is to be used for timing synchronization. The UE may read such SIB parameters upon selecting an NTN cell and apply the parameters to its stored historical synchronization data. In the example of FIG. 6, the IE 600 may include a set of parameters including at least one of a maximum age for the UE's own stored TA value (e.g., indicated by a parameter maxAgeHistoricalTA), a maximum age for the UE's own stored Doppler value (e.g., indicated by a parameter maxAgeHistoricalDoppler), a maximum age for network-provided assistance data elements such as ephemeris information (e.g., indicated by a parameter maxAgeNetworkAssistance), or a maximum UE movement distance for data validity (e.g., indicated by a parameter maxUeDistanceDisplacement).

In some implementations, the NE may use a dedicated RRC signaling mechanism to sigma some of the storage related parameters (i.e., for storage of the historical synchronization information) that are more UE-specific rather than common to all UEs. The RRC signaling may be based on a UE capability or upon successful completion of an initial access procedure. For example, the NE may include some parameters, such as updated TA values, updated Doppler values, updated ephemeris information, or other UE-specific parameters to override SIB-broadcasted timers. In some examples, as a fallback mechanism, the NE may pre-configure or define some default values for maximum age and displacement. The default values may ensure baseline behavior if SIBs may not yet be decoded or may lack the UE-specific parameters.

Implementations include preamble configurations for GNSS independent operation. In scenarios that involve NTN specific preamble formats, a maximum delay spread and timing uncertainty in NTN, particularly for a GNSS-independent UE to access the network, can potentially exceed the longest CPs offered by some (e.g., 5G NR long) preambles. For example, a LEO satellite moving rapidly can introduce significant variations in round-trip time (RTT) and Doppler across its footprint. If the timing error exceeds the CP duration, the gNB may experience inter-symbol interference (ISI) from the preamble itself, which may degrade detection performance.

Some implementations provide preamble formats for NTN with a longer CP duration (e.g., longer than CP durations used in some wireless communications systems). For example, long preamble formats are described with longer CP durations (e.g., from 500 μs to 1 ms) and optionally with longer guard times for NTN. The described preamble formats and/or guard times may be applied in difference scenarios, such as for GNSS independent scenarios, GNSS with lower accuracy, GNSS specific to NTN orbits (e.g., LEO, MEO, GEO), or for NTN UEs.

In some implementations, the described preamble formats may utilize ZC sequences with sequence lengths of 839 or 1151, and SCS of 1.25 and 7.5 kHz, and may include options for longer CPs. Such implementations may improve robustness against timing estimation errors. Alternatively, or in addition, the length of sequences may be increased to counter timing errors. In some implementations, the described (e.g., longer) preamble formats can be generated using a greater number of symbols to cover the satellite altitude. For example, instead of using format 2 that has a maximum duration above 3 ms with four OFDM symbols, the number of OFDM symbols may be doubled (e.g., a 3 dB processing gain and additional correlation length), where each of the symbols may use extended CPs (e.g., hundreds of us to milliseconds) such that a total preamble duration is sufficient to cover a time uncertainty of a LEO cell.

In some implementations, preamble formats are defined with respect to a constellation orbital distance, and an NTN UE may be configured to the described preamble formats based on an implicit or explicit indication. For example, a preamble format type (e.g., format 5) may be specified for LEO orbit for a constellation distance of 600-2000 Km, another format for LEO orbit specified for constellation distance of 2001-6000 km, etc. In such formats, an example difference is to have different length CPs covering the large round-trip time for a specific range of distance. In some implementations, the network may configure the NTN orbit specific format type to be used for RACH transmission in PRACH configuration (e.g., in PRACH common configuration (RACH-ConfigCommon)).

In some implementations, a UE may use the NTN orbit specific format type based on implicit indication in the NTN SIB (e.g., based on the ephemeris information broadcasted in the NTN SIB). Based on their self-assessed uncertainty level (e.g., no GNSS, no recent successful access, some historical GNSS data) or explicit network guidance via SIBs, a UE may select a preamble format with an appropriate CP length. In some implementations, existing formats such as format 0, 1, 2, and/or 3 may be used with extended CPs for NTN. Such implementations may be achieved by modifying tables that define the parameters for these formats (e.g., by updating the tables with a new column addition that defines extended CPs for NTN, possibly for different orbits. In such implementations, an NTN UE may explicitly use a column that defines extended CPs. In some implementations, a set of sequences are defined for NTN in scenarios of GNSS relaxed or GNSS independent scenarios, where the sequences are longer sequences with higher robustness against frequency offsets and have enhanced auto correlation properties in view of higher Doppler or time uncertainties. In at least one implementation, UEs may report support of extended CP preambles and/or GNSS independent specific RACH features during registration (e.g., via UE-CapabilityRAT-Container).

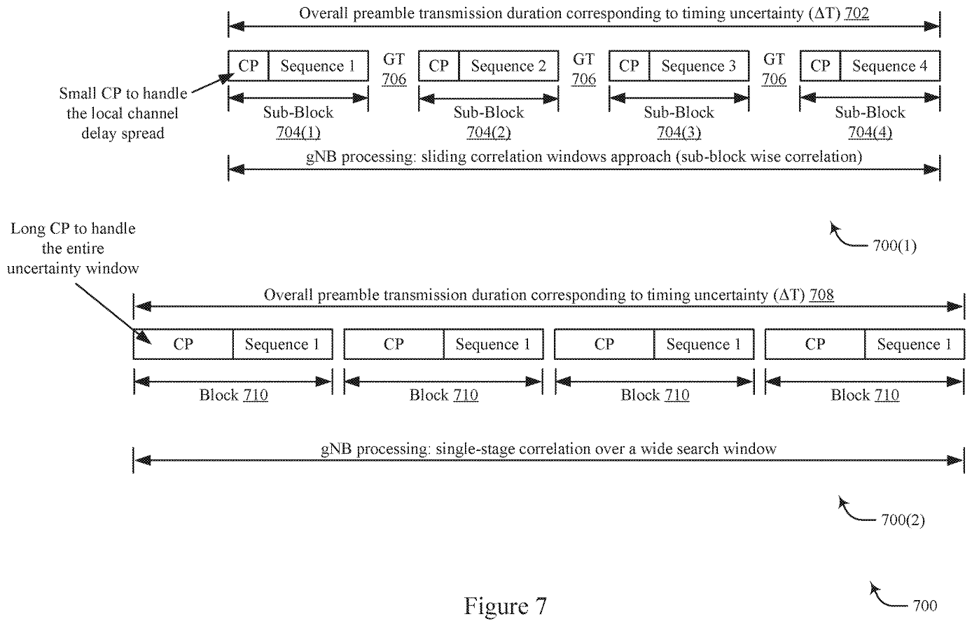

FIG. 7 illustrates example scenarios 700 in accordance with aspects of the present disclosure The scenarios 700 include a scenario 700(1) for a sub-block implementation for preamble formats and a scenario 700(2) for CP long preamble formats. The scenario 700(1) includes a preamble transmission duration 702 for a set of preambles and preamble sub-blocks 704 including a preamble sub-block 704(1), a preamble sub-block 704(2), a preamble sub-block 704(3), and a preamble sub-block 704(4). Each preamble sub-block 704 includes a respective CP and a respective sequence. Each individual preamble sub-block 704, for example, may include a CP that is generated based on a channel delay spread (e.g., multipath) rather than an entire propagation delay uncertainty (e.g., a preamble as a sequence of distinctly processable sub-blocks for staged synchronization). The sequences for the respective preamble sub-blocks 704 may be different or may include at least some identical sequences. Between the preamble sub-blocks 704 flexible guard times 706 may be inserted. The scenario 700(2) includes a preamble transmission duration 708 for preambles and preamble blocks 710. The preamble blocks 710 each include a respective CP and a respective preamble sequence. In implementations, the CP and the respective preamble sequence for each of the preamble blocks 710 is the same (e.g., identical). In some examples, the CP length of the preamble blocks 710 may be longer than the CP length of the preamble sub-blocks 704.

In implementations, a propagation delay uncertainty may be compensated by an NE 102 (e.g., a receiver device) being configured to search for the start of a sub-block sequence of the preamble sub-blocks 704 over a wider search window. As illustrated in the scenario 700(1), an NE 102 may apply a correlation of preamble sub-block 704 by preamble sub-block 704 (e.g., instead of applying one correlation over a time and frequency window (e.g., as illustrated in the scenario 700(2), such as for long format 2)). For example, for each preamble sub-block 704, the NE 102 may be configured to determine that it is to detect the preamble sub-block 704 at a nominal time tᵢ=t₀+(i−1)×(CP+data+guard time). However, because a UE 104 may be off to a time (up to RTT), the NE 102 may allow each preamble sub-block 704 correlation search to shift by plus or minus a CP length. As the NE 102 steps sequentially sub-block wise (e.g., preamble sub-block 704(1)→preamble sub-block 704(2)→ . . . preamble sub-block 704(n)), the NE 102 may attempt correlation at tᵢ−CP up to tᵢ+CP. The sliding correlation across multiple preamble sub-blocks 704 may cover a total window of [tᵢ−CP, t₀+(N−1)×Δ+CP], where Δ=CP+data+guard time. Such procedures may facilitate a staged synchronization process to resolve very large initial timing and frequency uncertainties inherent in GNSS-independent NTN operation, while potentially being more efficient with CP overhead than a single longer CP.

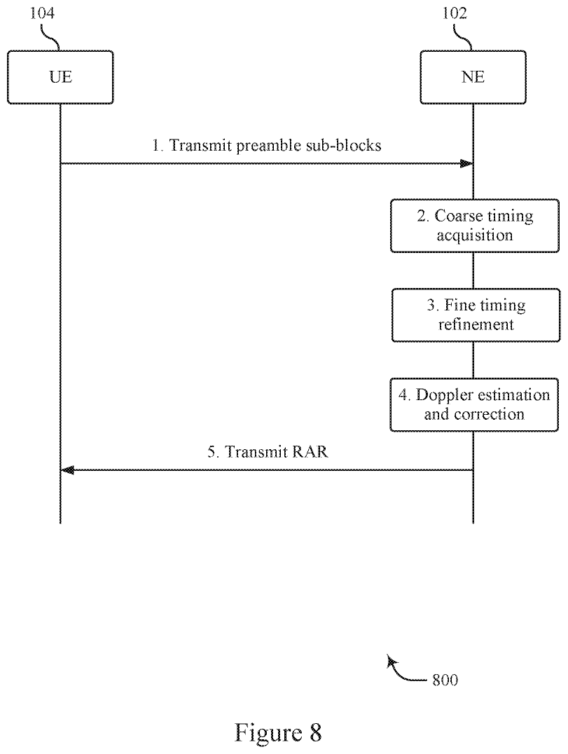

FIG. 8 illustrates an example of a sub-block procedure 800 in accordance with aspects of the present disclosure. The sub-block procedure 800, for example, represents an implementation of the scenario 700(1). In the sub-block procedure 800, at Step 1 a UE 104 transmits preamble sub-blocks to an NE 102. In implementations where the UE 104 doesn't have GNSS access, the UE 104 may transmit the preambles that are structured in sub-blocks (e.g., as illustrated in the scenario 700(1)). The preamble structure may be based on information received in SIB (e.g., PRACH SIB). In implementations, each preamble sub-block may include a respective CP dimensioned based on an expected channel delay spread (e.g., not dimensioned based on an entire satellite RTT uncertainty). In implementations, a first transmitted preamble sub-block (e.g., preamble sub-block 704(1)) may be a very robust, easily detectable sequence (e.g., in one example, the first transmitted preamble sub-block may be shorter than other transmitted preamble sub-blocks and/or have a unique characteristic). The first transmitted preamble sub-block, for example, may be configured for coarse timing acquisition. Subsequent transmitted preamble sub-blocks (e.g., transmitted preamble sub-blocks 704(2), 704(3), . . . 704(n)) may be identical to the first transmitted preamble sub-block or have a known relationship to the first transmitted preamble sub-block (e.g., different cyclic shifts of the same ZC sequence, or orthogonal sequences). Arrival times of the subsequent transmitted preamble sub-blocks relative to the first transmitted preamble sub-block may be used for fine timing refinement and potentially Doppler rate estimation. In implementations, at Step 1 the UE 104 may transmit an entire preamble sub-block with its best (but potentially very rough) initial TA estimate.

In the sub-block procedure 800, at Step 2 the NE 102 performs coarse timing acquisition. The NE 102, for example, performs a wide search for the first preamble sub-block (e.g., preamble sub-block 704(1)). The search window may be much larger than for terrestrial systems. Detection of the first preamble sub-block may provide an initial coarse TA estimate. A guard time against the large RTT uncertainty may be implicitly handled by the wider search window used by the NE 102 for the first preamble sub-block and the known timing structure between sub-blocks. At Step 3, the NE 102 performs fine timing refinement. For example, when the NE 102 detects the first preamble sub-block, the NE 102 may determine the approximate arrival window for subsequent preamble sub-blocks (e.g., preamble sub-blocks 704(2), 704(3), . . . 704(n)). The NE 102 can then use the known structure features such as cross correlation and known inter-sub-block gaps. In an example, cross correlation can cross-correlate preamble sub-block 704(1) with preamble sub-block 704(2) which can provide a precise differential timing measurement. In an example for using known inter-sub-block gaps, if guard times are non-zero and are known, the arrival time of preamble sub-blocks can be used as timing references. Implementations can thus enable the NE 102 to refine the TA measurement to a much higher precision than by just detecting a single, long preamble whose start time is highly uncertain.

In the sub-block procedure 800, at Step 4 the NE 102 performs Doppler estimation and correction. Coarse Doppler estimation may be performed from the frequency offset of the first preamble sub-block. Fine Doppler estimation and/or Doppler rate estimation may be performed by comparing the phase or frequency characteristics of known symbols within different sub-blocks (e.g., if sub-block 704(1) and sub-block 704(n) include the same sequence), the NE 102 can estimate the Doppler rate (change in Doppler over time). This is crucial for LEOs, where Doppler may change rapidly. The differential measurement across time-separated preamble sub-blocks may be more robust than attempting to estimate Doppler from a single, potentially very long symbol whose channel characteristics might not be constant over its entire duration. At Step 5, the NE 102 transmits a random access response (RAR) to the UE 104. The RAR (e.g., Msg2) includes the determined TA command and potentially initial frequency correction information.

Implementations include signaling aspects for preamble sub-block scenarios. In some implementations, a set of parameters are broadcasted by the network to assist UEs in transmission of sub-block based preamble structures, where the parameters may be broadcasted as part of PRACH configuration information element (IE) or a dedicated IE is used to describe the parameters. At least some of the following information may be included:

Number of sub-blocks: In some implementations, a number of blocks parameter defines how many sub-blocks may be included in the preamble format, and the parameter may be implicitly or explicitly indicated. In at least one example, the number of sub-blocks may be fixed for a format type, where an indication of format type may implicitly indicate the number of sub-blocks in the preamble structure. Alternatively, or in addition, a format structure may have a flexible number of sub-blocks. In scenarios of flexible number of sub-blocks, the parameter may be explicitly indicated as part of PRACH configuration.

Inter sub-block guard time: In some implementations, an NE 102 may configure the guard time that may be identical for all the sub-blocks, or the NE 102 may configure different GTs for different sub-blocks. In some implementations, when one guard time is configured, a UE 104 may apply this guard time for all inter sub-blocks. Alternatively, or in addition, when a UE 104 receives multiple GTs, the UE may apply the GTs across sub-blocks sequentially.

PRACH configuration index: A UE 104 may use the preamble parameters for each of the sub-blocks. In some examples, an NE 102 may signal an index (e.g., prach-ConfigurationIndex) that defines which prach-ConfigurationIndex values correspond to the sub-block preamble formats.

Sub-block sequencing rule: In some implementations, an NE 102 may configure a rule to define the relationship between sub-block sequences. For example, the sequences can be configured to be identical, configured to be cyclically shifted, and/or indices defining a predefined set of sequences for each of the sub-blocks may be configured.

Sub-block parameters: In some implementations, each preamble sub-block may have the same set of parameters (e.g., all sub-blocks use a same sequence and same CP duration). In such implementations, a single field may be indicated for each of the parameters. Alternatively, a separate set of parameters may be configured for each of the preamble sub-blocks, where the set of parameters may include: (1) Sequence length for sub-block: The sequence length could be different from standard L_RA length and defined specifically for sub-blocks used in NTN especially for the case of GNSS independent; (2) Cyclic prefix length for sub-block: CP, sized for channel delay spread, can be the same or different for each sub-block in the preamble structure; (3) Root sequence index for sub-block: a parameter defining root for each of the sequence used in sub-blocks. For example, each sub-block carries a different root sequence to enhance robustness and reduce false alarm risk, e.g., SB1→ZC root 37, SB2→ZC root 47 and so on; (4) Number of repetitions within sub-block: In some implementations, an NE 102 may configure repetitions for each of the sub-blocks as allowing repetitions within a sub-block would increase robustness. If configured with such a field, then a UE 104 may repeat each sub-block in contiguous manner if otherwise configured. In some implementations, the NE 102 may repeat each sub-block with different guard time. In some implementations, a UE 104 may be instructed to indicate its capability to support sub-block based preamble transmission. For example, a flag may be used that indicates the UE's ability to generate and transmit multi-sub-block preambles according to network configuration.

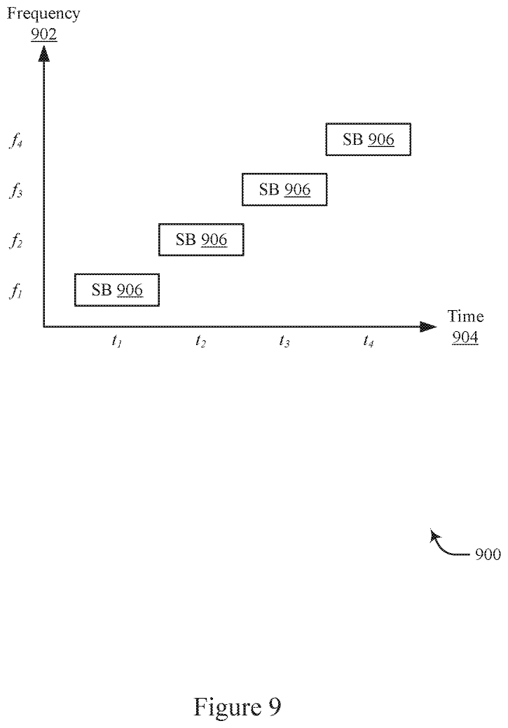

FIG. 9 illustrates an example scenario 900 for frequency hopping in accordance with aspects of the present disclosure. Frequency hopping, for example, may be utilized for improved Doppler estimation. The scenario 900 includes a frequency axis 902 indicating different frequency (e.g., RF) values and a time axis 904 indicating time values (e.g., ascending time values). The scenario 900 illustrates that a preamble sub-block (SB) 906 may be transmitted over different frequencies (f₁, f₂, f₃, f₄) over different respective time values (t₁, t₂, t₃, t₄). In implementations, frequency hopping may be combined with sub-block approaches to achieve improved frequency synchronization. For example, sub-blocks of a preamble may hop across different frequencies within an allocated PRACH bandwidth. Instead of transmitting sub-blocks on a same carrier frequency, for instance, each sub-block (or a group of sub-blocks) may be transmitted on a different, predefined frequency. In some implementations and using single frequency band, an NE 102 may measure one Doppler-shifted frequency. With frequency hopping, the NE 102 may receive multiple sub-blocks at different known frequencies, which may provide an enhanced set of information that may be used in LEO NTN systems. Moreover, NTN channels may experience frequency-selective fading, such as due to atmospheric effects (e.g., rain fade in higher frequency bands like Ka). Transmitting sub-blocks on different frequencies may provide frequency diversity. If one sub-block lands in a deep fade, others may not, which may increase the probability that at least part of the preamble is received with sufficient quality for detection and synchronization.

In scenarios involving frequency hopping (e.g., for LEO satellites), larger Doppler shifts cause high frequency ambiguity. A large Doppler shift can cause a received signal to appear as if it was transmitted on an adjacent subcarrier. By a UE 104 transmitting on different, known frequencies (e.g., f₁, f₂, f₃, . . . ), an NE 102 can more readily resolve this ambiguity. The NE 102 may determine a transmit frequency fₜₓ that the UE 104 intended to use for each sub-block. The NE 102 may measure the received frequency fᵣₓ. The Doppler shift for each sub-block i may be determined as Δfᵢ=fᵣₓ_{ᵢ}−fₜₓ_{ᵢ} By using multiple such measurements, the NE 102 can average them to get a highly accurate initial Doppler estimate, filtering out noise and other channel effects. In implementations, the frequency-hopped based preamble sub-block transmission allows for Doppler rate estimation. For example, if four preamble sub-blocks are used for transmission, the NE 102 can measure the Doppler shift at time t₁ (from SB1) and at t₄ (from SB4). This provides two data points (t₁, Δf₁) and (t₄, Δf₁), from which the rate of change (Δf/Δt) can be accurately estimated. In some implementations, frequency hopping may be applied for each of multiple preamble sub-blocks, as shown in the scenario 900. Alternatively, or in addition, a UE 104 may be configured to apply frequency hopping on groups of preamble sub-blocks. In some implementations, a UE capability may be added that indicates whether a UE can support frequency hopping for preamble transmission in RACH.

In some implementations, an NE 102 may configure a set of parameters as part of a broadcast SIB message that configures frequency hopping for RACH, e.g., as an IE in PRACH or NTN SIN configuration. Examples of such parameters include:

An enabler parameter indicating whether hopping is enabled or disabled for the associated PRACH resources, e.g., by hoppingMode-rXX ENUMERATED {enabled, disabled}.

A parameter defining the source of the hopping pattern, e.g., by hoppingPatternType-rXX ENUMERATED {predefined, explicitList, . . . }. For example, the UE 104 may be configured to look up a pre-standardized hopping sequence from a table within the 3GPP specifications (e.g., the UE 104 may be configured “predefined”). Alternatively, or in addition, the UE 104 may be configured by a dynamic hopping pattern by the NE 102 thus providing more flexibility (e.g., the UE 104 may be configured “explicitList”). The dynamic hopping pattern configuration or index for selection of pattern from a table may be provided by a separate parameter.

A parameter defining the total bandwidth over which the frequency hopping can occur relative to the initial PRACH frequency resource (e.g., by hoppingBandwidth-rXX INTEGER { }). For example, the integer value may present the number of physical resource blocks (PRBs).

A parameter providing the explicit, ordered list of frequency offsets for the hopping pattern (e.g., hoppingOffsetList-rXX). In one example, this parameter may be used when a hopping pattern is configured other than pre-defined. The size of the sequence may correspond to the number of sub-blocks configured for the preamble format. A value could be indicated to represent an offset in units of PRBs or a specific subcarrier spacing. In such scenarios, when transmitting a sub-blocked preamble, the UE may apply the nth value from this list as the frequency offset for the nth sub-block. For example: if the base PRACH frequency is f_base, number of sub-blocks is 4, and hopping offset list is configured as [0, +8, −4, +12] (in PRBs), the UE may transmit: SB1 at f_base; SB2 at f_base+(8*PRB_bandwidth); SB3 at f_base−(4*PRB_bandwidth); SB 4 at f_base+(12*PRB_bandwidth)

An identifier parameter that points to a predefined hopping pattern table in the 3GPP specifications. In one example, this parameter may be used when a hopping pattern is configured to be pre-defined. The values may be in integers corresponding to the number of rows in the table. The UE would use this index value to retrieve the corresponding sequence of offsets from an internal table defined by the standard. Table 1 below illustrates an example table for pre-defined frequency hopping patterns in accordance with one or more implementations. Table 1 may be optimized for different goals (e.g., maximum frequency separation, pseudo-randomness), as shown below.

TABLE 1

| | Offset pattern | |
|---|---|---|
| Index | (e.g., for four SBs) | Description |
| 0 | [0, 1, 2, 3] | linear |
| 1 | [0, −1, 0, +1] | symmetric |
| 2 | [0, +4, −2, +6] | Pseudo-Random High Diversity |
| . . . | . . . | . . . |

Implementations provide RACH procedure enhancements for time and frequency synchronization. For example, an NE 102 may configure dedicated RACH resources for GNSS independent cases. A UE 104, for example, can be configured with two sets of RACH resources. A first set of RACH resources may be used when the UE has time and frequency synchronization that exceeds a threshold (e.g., when GNSS information and/or connectivity is available). A second set of RACH resources may be available for PRACH transmission when a UE determines that time and frequency synchronization is below a threshold. The second set of RACH resources, for example, may be used when the UE uses less accurate information for uplink time and frequency synchronization, such as use of historical data (last known TA/location) or the use of coarse network assistance. In such scenarios, the UE may determine that its initial pre-compensation estimate has a large potential error.

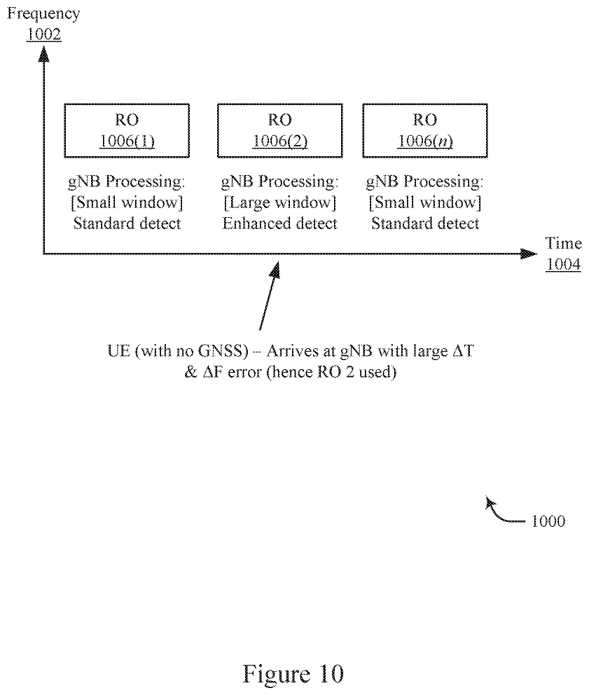

FIG. 10 illustrates an example scenario 1000 in accordance with aspects of the present disclosure. The scenario 1000, for example, illustrates implementations for dedicated ROs for GNSS-independent scenarios. The scenario 1000 includes a frequency axis 1002 and a time axis 1004. The scenario 1000 also includes ROs 1006 including an RO 1006(1), an RO 1006(2), and an RO 1006(n). As illustrated, the network may configure different RACH Occasions (ROs) in time and frequency for GNSS independent and GNSS dependent UE. For example, some ROs (e.g., RO 1006(2)) may be designated for high uncertainty UEs (e.g., UEs with limited or no GNSS access) and other ROs (e.g., ROs 1006(1), 1006(n)) may be designated for UEs having GNSS position estimates that exceed a threshold acceptability.

In implementations, a UE 104 without a GNSS fix or with a poor location estimates may transmit a RACH preamble targeting a high uncertainty resource (e.g., RO 1006(2)). Based on a lack of pre-compensation and long satellite path, the signal may arrive at the NE 102 with potentially large timing (ΔT) and frequency (ΔF) errors relative to the expected nominal arrival. For standard ROs (e.g., ROs 1006(1), 1006(n)), the NE 102 may use the standard detection methods with narrow time/frequency search windows which may be sufficient for UEs with acceptable synchronization (e.g., GNSS-assisted), thus saving processing power. For high uncertainty ROs (e.g., RO 1006(2)), the NE 102 may employ different (e.g., enhanced) detection operations. The different detection operations may involve searching over wider time and frequency windows, while using advanced algorithms capable of finding the standard preamble despite large potential errors. If the UE signal (with its errors) falls within the large search window of RO 1006(2) and the algorithm is robust enough, detection can succeed. In scenarios where high uncertainty UEs may have targeted ROs 1006(1), 1006(n), the UE signal may have fallen outside the narrow search window and thus resulted in a failed RACH procedure.

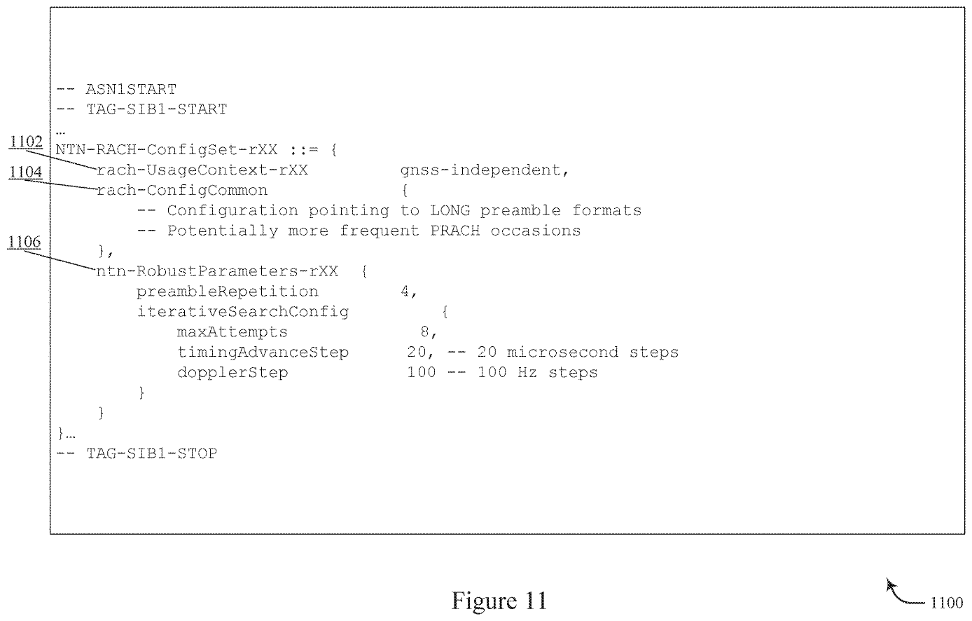

FIG. 11 illustrates an example IE 1100 in accordance with aspects of the present disclosure. In some implementations, a UE 104 may be configured via the IE 1100 (e.g., via SIB (e.g., NTN SIB or PRACH configuration SIB)) with a set of ROs explicitly defined for UEs with high time and frequency uncertainties. Examples of such UEs include GNSS independent UEs, UEs with low certainty position estimates, a set of ROs for UEs with low time and frequency uncertainties, etc. An NE 102 may be configured to allow UE assessment to choose which set of ROs are to be used for PRACH transmission. If a UE can calculate its position based on GNSS or other positioning method, then the UE may use ROs with low uncertainties, otherwise the UE may use high uncertainty ROs.

In some implementations, to configure the different sets of ROs, the IE 1100 includes a dedicated parameter indicating the type of ROs may be defined in SIB, where the parameter can be used as an explicit label for each configuration set. For example, a parameter 1102 rach-UsageContext may be used where the parameter tag may be set to either GNSS-aided (e.g., low uncertainty) or GNSS-independent (e.g., high uncertainty). For each of the tags, RO configuration parameters may be defined under the parameter 1102. For instance, if a UE matches its self-assessed state to the rach-UsageContext tag in the configuration list to GNSS-aided, the UE may use the RO configuration under GNSS-aided. The network may decide which contexts to support for the type of deployed scenario and may configure the corresponding resources for each of the tags.

In some implementations, when a usage context is set to GNSS-aided (e.g., low uncertainty) or GNSS-independent (e.g., high uncertainty), the network under each usage context may configure a basic set of parameters that define a RO for both cases. For example, the parameters defined under RACH-common configuration IE (e.g., a parameter 1104) may be reused and may include: (1) Frequency resource (e.g., msg1-FrequencyStart, msg1-FDM); (2) Time resources (e.g., prach-ConfigurationIndex which points to tables defining time slots and occasions); (3) Preambles type (e.g., totalNumberOfRA-Preambles, ssb-perRACH-OccasionAndCB-PreamblesPerSSB); (4) Preamble format (e.g., implicitly via prach-ConfigurationIndex which maps to formats such as long preamble format 2).

In some implementations, the network may configure another set of parameters using a dedicated label under usage context, where these parameters may be specific for GNSS independent cases and may have preference over common parameters, if configured under both labels. For example, a parameter 1106 (e.g., a tag/label (e.g., ntn-RobustParameters)) may be added in the same configuration. If the UE usage context is GNSS-independent, a set of parameters for robust RACH transmission may be additionally configured under this tag/label, otherwise, the fields may be empty. Some examples of additional parameters include: (1) Preamble repetitions per each RACH attempt (e.g., preambleRepetition). This parameter may be used to define preamble bundling, if used for additional robustness. A configured value may imply that a single RACH attempt includes transmitting the same preamble back-to-back according to value. An NE 102 may expect such repetitions/bundling and may non-coherently combine the energy from all receptions, which may improve the link budget and detection probability; (2) Parameters for iterative search, if enabled. These parameters may configure the UE's autonomous search behavior if its first bundled attempt fails. The parameters may instruct the UE how to systematically adjust its TA and Doppler for subsequent bundled attempts, which may prevent the UE from getting stuck on a bad initial estimate.

In some implementations, ROs for GNSS-independent and GNSS dependent scenarios may be implicitly indicated based on resource partitioning. Example rules for such implementations may be coded in the specification (e.g., 3GPP TS) or configured during initial setup. Some example implementations may include:

Preamble partitioning: In one example, a subset of preambles within a set of ROs is reserved for GNSS-independent UEs (e.g., preambles 32-63 out of 0-63). A UE may select a preamble based on its GNSS status without explicit instructions.

RO Partitioning: In another example, specific ROs may be implicitly assigned/reserved for GNSS-independent UEs based on time or frequency patterns. UEs may follow predefined rules to select these ROs (e.g., without explicit signaling). For example, the network may reserve every 4th RO in time (e.g., RO #0, #4, #8, etc.) for GNSS-independent UEs. The pattern may be predefined in the specification or set via a single parameter (e.g., n=4) during configuration. The UE may calculate the reserved ROs using a formula (e.g., RO_index mod n=0), where n is the interval (e.g., 4), based on system frame number (SFN) and/or slot timing.

In some implementations, the ROs may not be explicitly defined for GNSS-independent and dependent cases, and an optional flag may be used to indicate whether an extended detection window is enabled for the respective RO. In some implementations, the network may define a threshold value to indicate to UEs when the robust RACH resources are to be used. For instance, if an estimated location uncertainty exceeds a threshold, this triggers the UE to use robust RACH parameters (e.g., more repetitions, robust preamble format).

Implementations include UE-side iterative RACH with stepped pre-compensation adjustments. For example, a UE may employ an initial set of time and frequency adjustment parameters for an initial RACH attempt and instead of the UE retransmitting with the same parameters after a failure, the UE may adjust the time and frequency parameters for each subsequent attempt. The UE, for example, may calculate a best-effort initial TA estimate and Doppler estimate using available information (e.g., historical data, coarse network assistance from SIBs). The UE may then transmit its first RACH preamble (e.g., Msg1) using the estimated initial TA and Doppler values and may monitor for a RAR during its RAR window. If no RAR is received, the UE may determine that the RACH attempt has failed. Alternatively, or in addition to increasing power and retransmitting with the same parameters, the UE may calculate its new TA and Doppler based on a set of information and transmit a second RACH preamble with the new parameters. This process may continue iteratively until the UE is successful or has reached the maximum RACH attempt bound.

In some implementations, the network may provide a set of time and frequency adjustment parameters as part of SIB, where an IE may be used to indicate the parameters. In some examples, the parameters may be cell based or beam based. In some examples this provides a UE which has a high degree of uncertainty about its initial TA and Doppler pre-compensation (e.g., a GNSS-independent UE), with a controlled and network-defined search algorithm. Such implementations may mitigate random, inefficient RACH attempts and enable the UE to cover an expected uncertainty window, which may maximize the possibility of a successful connection while managing radio resources. A set of parameters for an iterative RACH procedure may include one or more of the following:

Maximum number of iterative attempts: A parameter that may specify a maximum number of preamble transmissions that a UE may perform while iterating through a TA/Doppler search pattern before considering the iterative attempt a failure. This parameter may serve as a termination condition to prevent the UE from transmitting indefinitely. For example, if a maximum number of iterative preamble transmissions is set to 8, the UE may transmit the preamble up to 8 times, each with a different TA/Doppler offset, before stopping this search. In some examples, if no RAR is received after the 8 attempts, the UE may proceed according to the higher-layer preamble TransMax logic (e.g., a parameter from the RACH-ConfigCommon IE that defines how many times a UE can re-attempt the entire random access procedure (e.g., after receiving a negative RAR or timing out)), which may involve a backoff timer before starting a new iterative search sequence.

Granularity of the timing search: A parameter that may specify the discrete step size by which a UE may adjust its TA between iterative attempts. The value may be defined in time units (e.g., defined by step sizes of microseconds). The selection of this value may involve a balance between a high step and a low step. For instance, a small step (e.g., 5 μs) may provide a fine-grained search, ensuring the UE remains within the network's narrow detection window. However, a small step may also involve that a UE makes more attempts (and thus more time and power) to cover a large uncertainty range. A large step (e.g., 80 μs) may cover an uncertainty range quickly but may risk overshooting the correct timing window entirely. In one example, the network may set the granularity value based on the network's timing resolution and a precision parameter. In some examples, a granularity value may be less than the effective duration of the CP to ensure that each iterative step moves the received signal into a new resolvable time window at the NE 102.

Granularity of the frequency search: A parameter that may specify a discrete step size for adjusting the Doppler pre-compensation. The Doppler step size may be defined in Hz. An example goal is to adjust the UE transmit frequency so that it arrives at the satellite within the NE 102 receiver tolerance. This tolerance may be set as a small fraction (e.g., 5-10%) of the PRACH subcarrier spacing (SCS) to avoid significant Inter-Carrier Interference (ICI). The NE 102 may configure the step size based on the SCS used for PRACH and the expected Doppler uncertainty. For example, for a 15 kHz SCS, a step size of a few hundred Hz may be utilized.

Algorithm application/search pattern: An NE 102 may configure to a UE 104 a parameter defining how to apply the time and frequency search algorithm (e.g., in one-dimensional (1D) or in two-dimensional (2D) space). For example, applying random search for timing and/or frequency synchronization may be inefficient, whereas applying a well-defined pattern may ensure a predictable UE behavior and allow for optimized NE 102 receiver strategies.

In some implementations, a UE 104 may be configured to use 1D space with TA first expanding or Doppler first expanding. For example, if configured with TA first, the UE 104 may hold its initial Doppler estimate constant and search in time, e.g., as: Try 1: (TA_est, Doppler_est); Try 2: (TA_est+1*TA_step, Doppler_est); Try 3: (TA_est−1*TA_step, Doppler_est); Try 4: (TA_est+2*TA_step, Doppler_est); etc.

In some implementations, a UE may be configured to apply 2D space such that the UE may adjust both TA and Doppler in an expanding spiral pattern from its initial estimate, e.g., as: Try 1: (TA_est, Doppler_est); Try 2: (TA_est+TA_step, Doppler_est); Try 3: (TA_est+TA_step, Doppler_est+Doppler_step); Try 4: (TA_est, Doppler_est+Doppler_step); etc.

Initial TA uncertainty range: A bounding parameter for the iterative search for timing error. This parameter may indicate a maximum expected TA error for a UE within a satellite beam/cell. The UE may use this value as a hard limit for TA search and may bound its iterative search for TA (e.g., not exceeding the initial TA value+/−initial TA uncertainty range/2). The network may calculate the initial TA uncertainty range based on the satellite's altitude, beam footprint diameter, and orbital mechanics. The initial TA uncertainty range may represent a maximum difference in Round-Trip Time (RTT) between a UE at the beam/cell center and a UE at the beam/cell edge.

Initial Doppler uncertainty range: This parameter may represent a bounding parameter for the iterative search for frequency error, and may specify a maximum expected Doppler shift deviation from the value at the beam/cell center. A UE 104 may use this parameter to constrain its Doppler search. An NE 102 may calculate this parameter based on a satellite's maximum tangential velocity relative to points on the edge of its coverage footprint.

Implementations include solutions for RACH repetitions. In some implementations, a repetition factor is configured by the network to repeat a preamble within one RO or across multiple ROs for UEs with GNSS access, for UEs without GNSS access, for UEs with GNSS access but with positioning estimate errors that exceed a threshold, or combinations thereof. In some implementations, the repetition factor may be explicitly configured by a parameter in SIB (e.g., PRACH configuration SIB or in NTN SIB).

In some implementations, a UE 104 may be configured by a parameter that indicates whether RACH repetitions are to be carried out within a RO or across ROs. For example, a tag can be used for indicating preamble repetitions within an RO or across ROs, via which parameters such as repetition factor and preamble format may be defined. The UE 104 may select the configured preamble and may send the preamble multiple times within the RO per the repetition factor. In implementations, if the repetition factor is configured to be complete within an RO, the network may configure RO duration long enough to fit the repeated preambles. Alternatively, or in addition, the UE may be configured to apply repetition across consecutive ROs. In such scenarios, if a repetition factor is configured under a tag of repetition across ROs, the UE may determine that a number of ROs to be used are equal to the number of repetitions. In one example, the network can also configure a RO scheduling pattern to indicate the gap between ROs for repeated preambles. For example, the network may configure a RO schedule of 2 ms with repetition factor of 3 and preamble format 1. The UE, in this case, may transmit preamble format 1 at t=Oms (RO1), t=2 ms (RO2) and t=4 ms (RO3).

In some implementations, power control parameters may be defined for each of the RACH repetitions, where each RACH repetition may have a same power control parameter, or each repeated preamble may have different power settings. In some implementations, the network may configure an enabler parameter (e.g., in SIB) indicating whether a RACH repetition is enabled or disabled. In some implementations, RACH repetitions may be indicated by the repetition parameter (e.g., when a repetition factor is indicated) and it may be implicitly assumed by the UE that repetition is to be applied. In some implementations, the RACH repetitions may be frequency hopped to facilitate enhanced Doppler estimation by the network. The network, for example, may configure a parameter to indicate whether the repetitions are to be frequency hopped. In implementations, a UE may indicate its capability to support preamble repetitions within an RO or across ROs to the network during registration (e.g., via UE-CapabilityRAT-Container).

Implementations provide for Msg2 enhancements. In some implementations, a network upon successful detection of RACH from a UE with no GNSS may configure a frequency correction command (FCC) in Msg 2 (e.g., including a Timing Advance Command (TAC), e.g., by a new FCC field). The UE 104, upon receiving the RAR, may decode both the TAC and the FCC. The UE 104 may apply the TA correction to its uplink timing and adjust its local oscillator frequency based on the FCC for a subsequent Msg3 (e.g., RRC Connection Request) transmission. In some implementations a field (e.g., 8 bits) may be used that allows for 256 quantized frequency correction steps. The network may configure the step size (e.g., 50 Hz, 100 Hz per step) in a SIB. For instance, an 8-bit field with a 100 Hz step size may command corrections over a +/−12.7 kHz range.

Implementations provide for an extended and dynamic random-access response (RAR) window. In implementations, the network may utilize longer windows to detect RACH attempts for UEs with no GNSS. Moreover, the propagation delay from the satellite to the ground gateway and back to the satellite (the feeder link delay) may add significant and potentially variable latency to the RAR transmission. A standard ra-ResponseWindow configured in SIBs may be too short to accommodate this entire round trip, causing the UE to miss the RAR and declare a failed attempt prematurely. This could be compensated by configuring a sufficiently long window. In some implementations, the range of values for the ra-ResponseWindow IE in the RACH-ConfigCommon structure may be extended, e.g., up to 320 slots. In some implementations, the network may signal different RAR window lengths for different RACH resource sets. For example, a robust RACH resource set used by GNSS-independent UEs may be associated with a longer, more conservative RAR window to account for any additional processing time an NE 102 uses for its wide-window search algorithms.

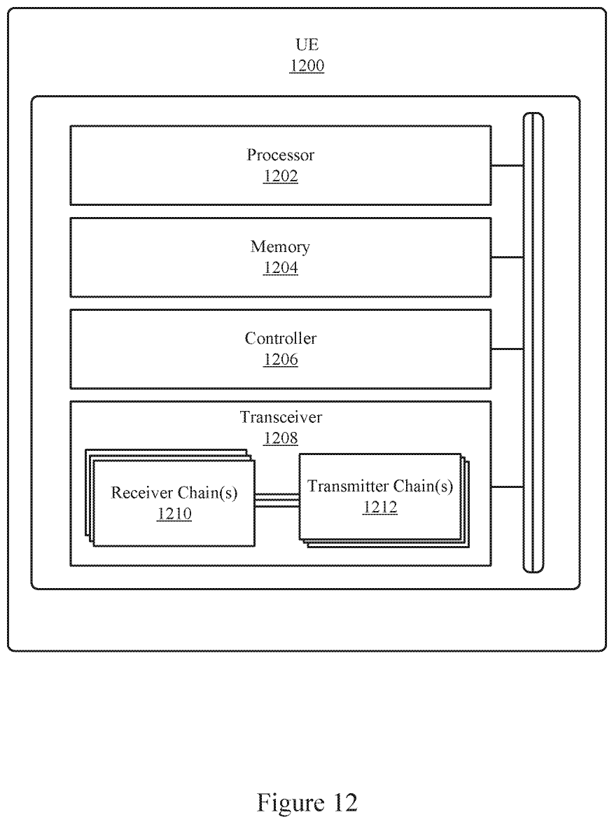

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to or operable to support a means for receiving assistance information for synchronization in an NTN, where the assistance information is applicable to a coverage area and includes a set of baseline synchronization correction parameters; selecting, based on a GNSS location being unavailable for the UE, a baseline synchronization correction parameter from the set of baseline synchronization correction parameters; calculating an initial uplink pre-compensation value by applying the selected baseline synchronization correction parameter to a baseline time and frequency synchronization parameter; and transmitting an uplink signal for initial access using the initial uplink pre-compensation value.

Additionally, the UE 1200 may be configured to support any one or combination of receiving second assistance information for the synchronization, where the second assistance information includes a set of zone identifiers, and where each zone identifier of the set of zone identifiers is associated with a zone and at least one zone-specific synchronization correction parameter; and selecting a zone identifier from the set of zone identifiers based on a coarse location of the UE, wherein the baseline synchronization correction parameter is selected based on the selected zone identifier, and wherein the baseline synchronization correction parameter corresponds to a respective zone-specific synchronization parameter associated with the selected zone identifier; where the zone is associated with an SSB beam; where the assistance information further includes satellite ephemeris data, and where the respective zone-specific synchronization correction parameter is selected based on the satellite ephemeris data; or where, in response to the set of zone identifiers excluding the coarse location of the UE, the initial uplink pre-compensation value is calculated based on the assistance information.

Additionally, or alternatively, the UE 1200 may be configured to support any one or combination of initiating a validity timer associated with the assistance information or the second assistance information; and refraining from using the assistance information or the second assistance information if an age of the assistance information exceeds a duration of the validity timer; transmitting capability information that indicates support for synchronization in the NTN, where one or more of the assistance information or the second assistance information is received based on the transmitted capability information; where the baseline time and frequency synchronization parameter is a baseline TA value applicable to a reference point of the coverage area; where the zone-specific synchronization correction parameter is a differential TA value, and where calculating the initial uplink pre-compensation value includes adding the differential TA value to the baseline TA value; where the baseline time and frequency synchronization parameter is a common Doppler pre-compensation value applicable to a reference point of the coverage area; where the zone-specific synchronization correction parameter is a differential Doppler value, and where calculating the initial uplink pre-compensation value includes applying the differential Doppler value to the common Doppler pre-compensation value; or where calculating the initial pre-compensation value includes receiving an indication of an NRT, where the initial uplink pre-compensation value is calculated based on the NRT.

Additionally, or alternatively, the UE 1200 may support at least one memory (e.g., the memory 1204) and at least one processor (e.g., the processor 1202) coupled with the at least one memory and configured to cause the UE to receive assistance information for synchronization in an NTN, where the assistance information is applicable to a coverage area and includes a set of baseline synchronization correction parameters; select, based on a GNSS location being unavailable for the UE, a baseline synchronization correction parameter from the set of baseline synchronization correction parameters; calculate an initial uplink pre-compensation value by applying the selected baseline synchronization correction parameter to a baseline time and frequency synchronization parameter; and transmitting an uplink signal for initial access using the initial uplink pre-compensation value.

Additionally, the UE 1200 may be configured to support any one or combination of receiving second assistance information for the synchronization, where the second assistance information includes a set of zone identifiers, and where each zone identifier of the set of zone identifiers is associated with a zone and at least one zone-specific synchronization correction parameter; and selecting a zone identifier from the set of zone identifiers based on a coarse location of the UE, wherein the baseline synchronization correction parameter is selected based on the selected zone identifier, and wherein the baseline synchronization correction parameter corresponds to a respective zone-specific synchronization parameter associated with the selected zone identifier; where the zone is associated with an SSB beam; where the assistance information further includes satellite ephemeris data, and where the respective zone-specific synchronization correction parameter is selected based on the satellite ephemeris data; or where, in response to the set of zone identifiers excluding the coarse location of the UE, the initial uplink pre-compensation value is calculated based on the assistance information.

Additionally, or alternatively, the UE 1200 may be configured to support any one or combination of initiating a validity timer associated with the assistance information or the second assistance information; and refraining from using the assistance information or the second assistance information if an age of the assistance information exceeds a duration of the validity timer; transmitting capability information that indicates support for synchronization in the NTN, where one or more of the assistance information or the second assistance information is received based on the transmitted capability information; where the baseline time and frequency synchronization parameter is a baseline TA value applicable to a reference point of the coverage area; where the zone-specific synchronization correction parameter is a differential TA value, and where calculating the initial uplink pre-compensation value includes adding the differential TA value to the baseline TA value; where the baseline time and frequency synchronization parameter is a common Doppler pre-compensation value applicable to a reference point of the coverage area; where the zone-specific synchronization correction parameter is a differential Doppler value, and where calculating the initial uplink pre-compensation value includes applying the differential Doppler value to the common Doppler pre-compensation value; or where calculating the initial pre-compensation value includes receiving an indication of an NRT, where the initial uplink pre-compensation value is calculated based on the NRT.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

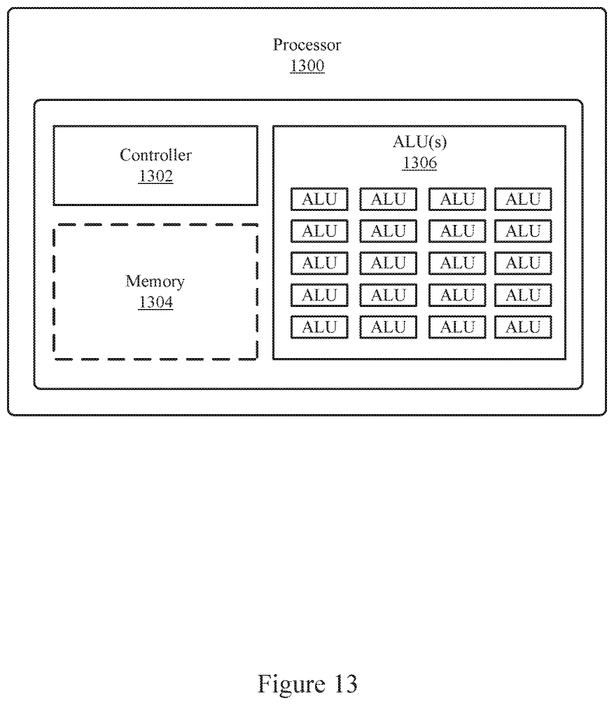

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to receive assistance information for synchronization in an NTN, where the assistance information is applicable to a coverage area and includes a set of baseline synchronization correction parameters; select, based on a GNSS location being unavailable for the UE, a baseline synchronization correction parameter from the set of baseline synchronization correction parameters; calculate an initial uplink pre-compensation value by applying the selected baseline synchronization correction parameter to a baseline time and frequency synchronization parameter; and transmit an uplink signal for initial access using the initial uplink pre-compensation value.

Additionally, the processor 1300 may be configured to or operable to support any one or combination of receiving second assistance information for the synchronization, where the second assistance information includes a set of zone identifiers, and where each zone identifier of the set of zone identifiers is associated with a zone and at least one zone-specific synchronization correction parameter; and selecting a zone identifier from the set of zone identifiers based on a coarse location of the UE, wherein the baseline synchronization correction parameter is selected based on the selected zone identifier, and wherein the baseline synchronization correction parameter corresponds to a respective zone-specific synchronization parameter associated with the selected zone identifier; where the zone is associated with an SSB beam; where the assistance information further includes satellite ephemeris data, and where the respective zone-specific synchronization correction parameter is selected based on the satellite ephemeris data; or where, in response to the set of zone identifiers excluding the coarse location of the UE, the initial uplink pre-compensation value is calculated based on the assistance information.

Additionally, or alternatively, the processor 1300 may be configured to or operable to support any one or combination of initiating a validity timer associated with the assistance information or the second assistance information; and refraining from using the assistance information or the second assistance information if an age of the assistance information exceeds a duration of the validity timer; transmitting capability information that indicates support for synchronization in the NTN, where one or more of the assistance information or the second assistance information is received based on the transmitted capability information; where the baseline time and frequency synchronization parameter is a baseline TA value applicable to a reference point of the coverage area; where the zone-specific synchronization correction parameter is a differential TA value, and where calculating the initial uplink pre-compensation value includes adding the differential TA value to the baseline TA value; where the baseline time and frequency synchronization parameter is a common Doppler pre-compensation value applicable to a reference point of the coverage area; where the zone-specific synchronization correction parameter is a differential Doppler value, and where calculating the initial uplink pre-compensation value includes applying the differential Doppler value to the common Doppler pre-compensation value; or where calculating the initial pre-compensation value includes receiving an indication of an NRT, where the initial uplink pre-compensation value is calculated based on the NRT.

Additionally, or alternatively, the processor 1300 may be configured to or operable to support at least one controller (e.g., the controller 1302) coupled with at least one memory (e.g., the memory 1304) and configured to cause the processor to transmit assistance information for synchronization in an NTN, where the assistance information is applicable to a coverage area and includes a set of baseline synchronization correction parameters; and receive an uplink signal for initial access indicating an initial uplink pre-compensation value, where the initial uplink pre-compensation value is based on a baseline synchronization correction parameter being applied to a baseline time and frequency synchronization parameter, and where the baseline synchronization correction parameter is based on a GNSS location being unavailable for a UE.

Additionally, or alternatively, the processor 1300 may be configured to or operable to support any one or combination of transmitting second assistance information for the uplink synchronization, where the second assistance information includes a set of zone identifiers and each zone identifier of the set of zone identifiers is associated with a zone and at least one zone-specific synchronization correction parameter, and where the initial uplink pre-compensation value is based on a zone-specific synchronization correction parameter associated with the zone identifier being applied to the baseline time and frequency synchronization parameter, the zone identifier based on a coarse location of the UE; where the zone is associated with an SSB beam; where the assistance information further includes satellite ephemeris data, and where the respective zone-specific synchronization correction parameter is selected based on the satellite ephemeris data; or where, in response to the set of zone identifiers excluding the coarse location of the UE, the initial uplink pre-compensation value is calculated based on the assistance information.

Additionally, or alternatively, the processor 1300 may be configured to or operable to support any one or combination of receiving capability information that indicates support for synchronization in the NTN, where one or more of the assistance information or the second assistance information is transmitted based on the received capability information; where the baseline time and frequency synchronization parameter is a baseline TA value applicable to a reference point of the coverage area; where the zone-specific synchronization correction parameter is a differential TA value, and where the initial uplink pre-compensation value is based on the differential TA value being added to the baseline TA value; where the baseline time and frequency synchronization parameter is a common Doppler pre-compensation value applicable to a reference point of the coverage area; where the zone-specific synchronization correction parameter is a differential Doppler value, and where the initial uplink pre-compensation value is based on the differential Doppler value being applied to the common Doppler pre-compensation value; or transmitting an indication of an NRT, where the initial uplink pre-compensation value is based on the NRT.

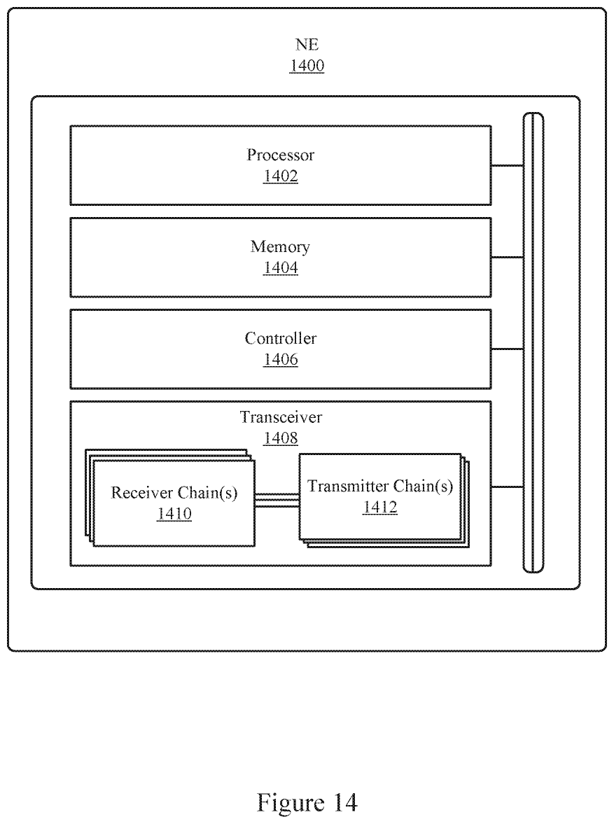

FIG. 14 illustrates an example of an NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to or operable to support a means for transmitting assistance information for synchronization in an NTN, where the assistance information is applicable to a coverage area and includes a set of baseline synchronization correction parameters; and receiving an uplink signal for initial access indicating an initial uplink pre-compensation value, where the initial uplink pre-compensation value is based on a baseline synchronization correction parameter being applied to a baseline time and frequency synchronization parameter, and where the baseline synchronization correction parameter is based on a GNSS location being unavailable for a UE.

Additionally, the NE 1400 may be configured to support any one or combination of transmitting second assistance information for the uplink synchronization, where the second assistance information includes a set of zone identifiers and each zone identifier of the set of zone identifiers is associated with a zone and at least one zone-specific synchronization correction parameter, and where the initial uplink pre-compensation value is based on a zone-specific synchronization correction parameter associated with the zone identifier being applied to the baseline time and frequency synchronization parameter, the zone identifier based on a coarse location of the UE; where the zone is associated with an SSB beam; where the assistance information further includes satellite ephemeris data, and where the respective zone-specific synchronization correction parameter is selected based on the satellite ephemeris data; or where, in response to the set of zone identifiers excluding the coarse location of the UE, the initial uplink pre-compensation value is calculated based on the assistance information.

Additionally, or alternatively, the NE 1400 may be configured to support any one or combination of receiving capability information that indicates support for synchronization in the NTN, where one or more of the assistance information or the second assistance information is transmitted based on the received capability information; where the baseline time and frequency synchronization parameter is a baseline TA value applicable to a reference point of the coverage area; where the zone-specific synchronization correction parameter is a differential TA value, and where the initial uplink pre-compensation value is based on the differential TA value being added to the baseline TA value; where the baseline time and frequency synchronization parameter is a common Doppler pre-compensation value applicable to a reference point of the coverage area; where the zone-specific synchronization correction parameter is a differential Doppler value, and where the initial uplink pre-compensation value is based on the differential Doppler value being applied to the common Doppler pre-compensation value; or transmitting an indication of an NRT, where the initial uplink pre-compensation value is based on the NRT.

Additionally, or alternatively, the NE 1400 may support at least one memory (e.g., the memory 1404) and at least one processor (e.g., the processor 1402) coupled with the at least one memory and configured to cause the NE to transmit assistance information for synchronization in an NTN, where the assistance information is applicable to a coverage area and includes a set of baseline synchronization correction parameters; and receive an uplink signal for initial access indicating an initial uplink pre-compensation value, where the initial uplink pre-compensation value is based on a baseline synchronization correction parameter being applied to a baseline time and frequency synchronization parameter, and where the baseline synchronization correction parameter is based on a GNSS location being unavailable for a UE.

Additionally, the NE 1400 may be configured to support any one or combination of transmitting second assistance information for the uplink synchronization, where the second assistance information includes a set of zone identifiers and each zone identifier of the set of zone identifiers is associated with a zone and at least one zone-specific synchronization correction parameter, and where the initial uplink pre-compensation value is based on a zone-specific synchronization correction parameter associated with the zone identifier being applied to the baseline time and frequency synchronization parameter, the zone identifier based on a coarse location of the UE; where the zone is associated with an SSB beam; where the assistance information further includes satellite ephemeris data, and where respective the zone-specific synchronization correction parameter is selected based on the satellite ephemeris data; or where, in response to the set of zone identifiers excluding the coarse location of the UE, the initial uplink pre-compensation value is calculated based on the assistance information.

Additionally, or alternatively, the NE 1400 may be configured to support any one or combination of receiving capability information that indicates support for synchronization in the NTN, where one or more of the assistance information or the second assistance information is transmitted based on the received capability information; where the baseline time and frequency synchronization parameter is a baseline TA value applicable to a reference point of the coverage area; where the zone-specific synchronization correction parameter is a differential TA value, and where the initial uplink pre-compensation value is based on the differential TA value being added to the baseline TA value; where the baseline time and frequency synchronization parameter is a common Doppler pre-compensation value applicable to a reference point of the coverage area; where the zone-specific synchronization correction parameter is a differential Doppler value, and where the initial uplink pre-compensation value is based on the differential Doppler value being applied to the common Doppler pre-compensation value; or transmitting an indication of an NRT, where the initial uplink pre-compensation value is based on the NRT.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

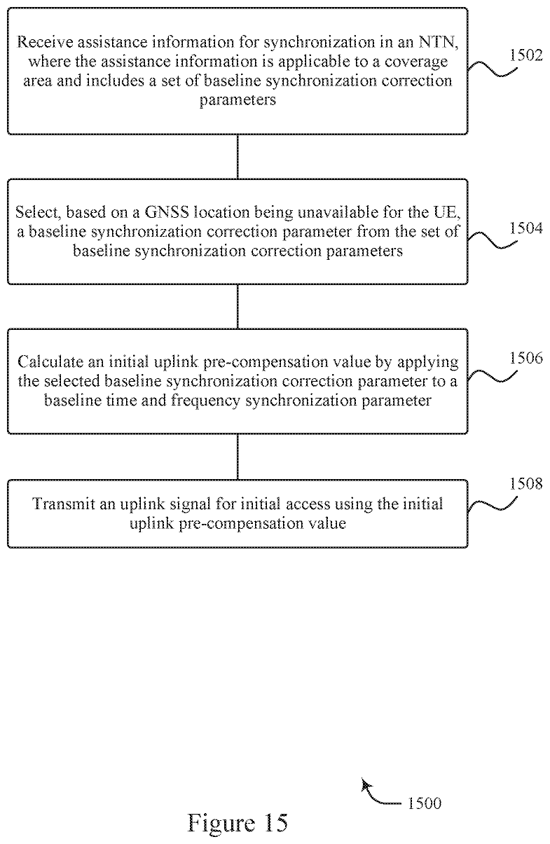

FIG. 15 illustrates a flowchart of a method 1500 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1502, the method may include receiving assistance information for synchronization in an NTN, where the assistance information is applicable to a coverage area and includes a set of baseline synchronization correction parameters. The operations of 1502 may be performed in accordance with examples as described herein. In some implementations, aspects of the operations of 1502 may be performed by a UE as described with reference to FIG. 12.

At 1504, the method may include selecting, based on a GNSS location being unavailable for the UE, a baseline synchronization correction parameter from the set of baseline synchronization correction parameters. The operations of 1504 may be performed in accordance with examples as described herein. In some implementations, aspects of the operations of 1504 may be performed by a UE as described with reference to FIG. 12.

At 1506, the method may include calculating an initial uplink pre-compensation value by applying the selected baseline synchronization correction parameter to a baseline time and frequency synchronization parameter. The operations of 1506 may be performed in accordance with examples as described herein. In some implementations, aspects of the operations of 1506 may be performed a UE as described with reference to FIG. 12.

At 1508, the method may include transmitting an uplink signal for initial access using the initial uplink pre-compensation value. The operations of 1508 may be performed in accordance with examples as described herein. In some implementations, aspects of the operations of 1508 may be performed a UE as described with reference to FIG. 12.

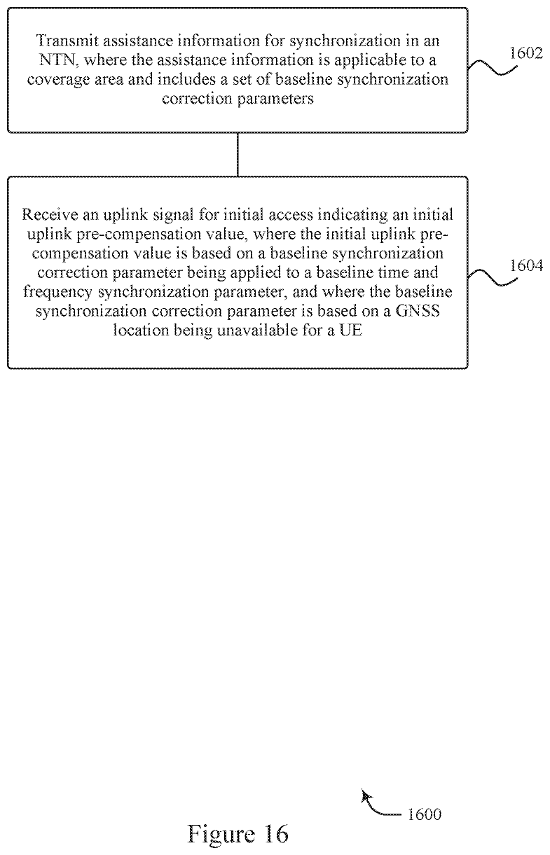

FIG. 16 illustrates a flowchart of a method 1600 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1602, the method may include transmitting assistance information for synchronization in an NTN, where the assistance information is applicable to a coverage area and includes a set of baseline synchronization correction parameters. The operations of 1602 may be performed in accordance with examples as described herein. In some implementations, aspects of the operations of 1602 may be performed by an NE as described with reference to FIG. 14.

At 1604, the method may include receiving an uplink signal for initial access indicating an initial uplink pre-compensation value, where the initial uplink pre-compensation value is based on a baseline synchronization correction parameter being applied to a baseline time and frequency synchronization parameter, and where the baseline synchronization correction parameter is based on a GNSS location being unavailable for a UE. The operations of 1604 may be performed in accordance with examples as described herein. In some implementations, aspects of the operations of 1604 may be performed by an NE as described with reference to FIG. 14.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive assistance information for synchronization in a non-terrestrial network (NTN), wherein the assistance information is applicable to a coverage area and comprises a set of baseline synchronization correction parameters;
select, based at least in part on a Global Navigation Satellite System (GNSS) location being unavailable for the UE, a baseline synchronization correction parameter from the set of baseline synchronization correction parameters;
calculate an initial uplink pre-compensation value by applying the selected baseline synchronization correction parameter to a baseline time and frequency synchronization parameter; and
transmit an uplink signal for initial access using the initial uplink pre-compensation value.

2. The UE of claim 1, wherein the at least one processor is further operable to cause the UE to:
receive second assistance information for the synchronization, wherein the second assistance information comprises a set of zone identifiers, and wherein each zone identifier of the set of zone identifiers is associated with a zone and at least one zone-specific synchronization correction parameter; and
select a zone identifier from the set of zone identifiers based at least in part on a coarse location of the UE, wherein the baseline synchronization correction parameter is selected based at least in part on the selected zone identifier,
wherein the baseline synchronization correction parameter corresponds to a respective zone-specific synchronization correction parameter associated with the selected zone identifier.

3. The UE of claim 2, wherein the zone is associated with a synchronization signal block (SSB) beam.

4. The UE of claim 2, wherein the assistance information further comprises satellite ephemeris data, and wherein the respective zone-specific synchronization correction parameter is selected based at least in part on the satellite ephemeris data.

5. The UE of claim 2, wherein, in response to the set of zone identifiers excluding the coarse location of the UE, the initial uplink pre-compensation value is calculated based at least in part on the assistance information.

6. The UE of claim 2, wherein the at least one processor is further configured to cause the UE to:
initiating a validity timer associated with the assistance information or the second assistance information; and
refrain from using the assistance information or the second assistance information if an age of the assistance information exceeds a duration of the validity timer.

7. The UE of claim 2, wherein the at least one processor is further configured to cause the UE to transmit capability information that indicates support for synchronization in the NTN, wherein one or more of the assistance information or the second assistance information is received based at least in part on the transmitted capability information.

8. The UE of claim 2, wherein the baseline time and frequency synchronization parameter is a baseline timing advance (TA) value applicable to a reference point of the coverage area and the zone-specific synchronization correction parameter is a differential TA value, and wherein, to calculate the initial uplink pre-compensation value, the at least one processor is further configured to cause the UE to add the differential TA value to the baseline TA value.

9. The UE of claim 2, wherein the baseline time and frequency synchronization parameter is a common Doppler pre-compensation value applicable to a reference point of the coverage area and the zone-specific synchronization correction parameter is a differential Doppler value, and wherein, to calculate the initial uplink pre-compensation value, the at least one processor is further configured to cause the UE to apply the differential Doppler value to the common Doppler pre-compensation value.

10. The UE of claim 1, wherein, to calculate the initial uplink pre-compensation value, the at least one processor is further operable to cause the UE to receive an indication of a network reference time (NRT), wherein the initial uplink pre-compensation value is calculated based at least in part on the NRT.

11. A network equipment (NE) for wireless communication, comprising:
at least one memory; and
at least one processor coupled with the at least one memory and operable to cause the NE to:
transmit assistance information for synchronization in a non-terrestrial network (NTN), wherein the assistance information is applicable to a coverage area and comprises a set of baseline synchronization correction parameters; and
receive an uplink signal for initial access indicating an initial uplink pre-compensation value, wherein the initial uplink pre-compensation value is based at least in part on a baseline synchronization correction parameter being applied to a baseline time and frequency synchronization parameter, and wherein the baseline synchronization correction parameter is based at least in part on a Global Navigation Satellite System (GNSS) location being unavailable for a user equipment (UE).

12. The NE of claim 11, wherein the at least one processor is further operable to cause the NE to transmit second assistance information for the synchronization,
wherein the second assistance information comprises a set of zone identifiers and each zone identifier of the set of zone identifiers is associated with a zone and at least one zone-specific synchronization correction parameter,
wherein the baseline synchronization correction parameter is based on a zone identifier selected from the set of zone identifiers based at least in part on a coarse location of the UE, and
wherein the baseline synchronization correction parameter is a respective zone-specific synchronization correction parameter associated with the zone identifier.

13. The NE of claim 12, wherein the assistance information further comprises satellite ephemeris data, and wherein the respective zone-specific synchronization correction parameter is selected based at least in part on the satellite ephemeris data.

14. The NE of claim 12, wherein, in response to the set of zone identifiers excluding the coarse location of the UE, the initial uplink pre-compensation value is based at least in part on the assistance information.

15. The NE of claim 12, wherein the at least one processor is further configured to cause the NE to receive capability information that indicates UE synchronization in the NTN, wherein one or more of the assistance information or the second assistance information is transmitted based at least in part on the received capability information.

16. The NE of claim 12, wherein the baseline time and frequency synchronization parameter is a baseline timing advance (TA) value applicable to a reference point of the coverage area and wherein the zone-specific synchronization correction parameter is a differential TA value, and wherein the initial uplink pre-compensation value is based at least in part on the differential TA value being added to the baseline TA value.

17. The NE of claim 12, wherein the baseline time and frequency synchronization parameter is a common Doppler pre-compensation value applicable to a reference point of the coverage area and the zone-specific synchronization correction parameter is a differential Doppler value, and wherein the initial uplink pre-compensation value is based at least in part on the differential Doppler value being applied to the common Doppler pre-compensation value.

18. The NE of claim 11, wherein the at least one processor is further operable to cause the NE to transmit an indication of a network reference time (NRT), wherein the initial uplink pre-compensation value is based at least in part on the NRT.

19. A method performed by a user equipment (UE), the method comprising:
receiving assistance information for synchronization in a non-terrestrial network (NTN), wherein the assistance information is applicable to a coverage area and comprises a set of baseline synchronization correction parameters;
selecting, based at least in part on a Global Navigation Satellite System (GNSS) location being unavailable for the UE, a baseline synchronization correction parameter from the set of baseline synchronization correction parameters;
calculating an initial uplink pre-compensation value by applying the selected baseline synchronization correction parameter to a baseline time and frequency synchronization parameter; and
transmitting an uplink signal for initial access using the initial uplink pre-compensation value.

20. A method performed by a network equipment (NE), the method comprising:
transmitting assistance information for synchronization in a non-terrestrial network (NTN), wherein the assistance information is applicable to a coverage area and comprises a set of baseline synchronization correction parameters; and
receiving an uplink signal for initial access indicating an initial uplink pre-compensation value, wherein the initial uplink pre-compensation value is based at least in part on a baseline synchronization correction parameter being applied to a baseline time and frequency synchronization parameter, and wherein the baseline synchronization correction parameter is based at least in part on a Global Navigation Satellite System (GNSS) location being unavailable for a user equipment (UE).
